(19) United States
(12) Patent Application Publication
(10) Pub. No.: US 2013/0238680 A1
(43) Pub. Date: Sep. 12, 2013

(54) DECIMAL ABSOLUTE VALUE ADDER

(71) Applicant: FUJITSU LIMITED, Kawasaki-shi (JP)

(72) Inventor: Hiroaki ATSUMI, Kawasaki (JP)

(73) Assignee: FUJITSU LIMITED, Kawasaki-shi (JP)

(21) Appl. No.: 13/873,517

(22) Filed: Apr. 30, 2013

Related U.S. Application Data
(63) Continuation of application No. PCT/JP2010/071923, filed on Dec. 7, 2010.

(51) Int. Cl. G06F 7/544

(52) U.S. Cl. CPC G06F 7/544
USPC 708/201

(57) ABSTRACT

A decimal absolute value adder includes a first circuit adding two operands for a first result; a second circuit adding the two operands to 10 for a second result; a third circuit adding the two operands to 6 for a third result; a fourth circuit adding the two operands to 1 for a fourth result; a fifth circuit adding the two operands to 11 for a fifth result; a sixth circuit adding the two operands to 7 for a sixth result; and a selection circuit selecting the first, second, fourth or fifth result when adding two numbers of identical signs or adding two numbers of different signs resulting in a non-negative result, and selecting a 1's complement of the first, third, fourth or sixth result when adding two numbers of different signs resulting in a negative result.

### CROSS-REFERENCE TO RELATED APPLICATION

This patent application is based upon and claims the benefit of priority under 35 USC 120 and 365(c) of PCT application JP2010/071923 filed in Japan on Dec. 7, 2010, the entire contents of which are incorporated herein by reference.

### FIELD

The embodiments discussed herein are related to a decimal absolute value adder.

### BACKGROUND

A decimal operation correction function adder is known. In the decimal operation correction function adder, based on bit patterns of an addend and an augend of each digit of a decimal number, an addition result assuming no carry signal from the low digit and an addition result assuming a carry signal from the low digit are extracted. Then, a decimal operation corrected addition result is selectively extracted based on whether there is a carry signal from the low digit and whether there is a carry signal from a target digit.

Further, a decimal operation circuit is known having the following configuration. In the decimal operation circuit, an operation part is provided and carries out, at a time of a main operation of “first operand-second operand”, an operation of “second operand-first operand” in parallel. Then, when the result of the main operation is negative, the operation result value of the operation part is selected and is outputted instead of the result value of the main operation. Thus, a complement process is made unnecessary, the delay otherwise occurring at a time of re-complement is eliminated, and the processing performance is improved.

Further, a subtractor is known having the following configuration. In the subtractor, two operands having mutually identical signs are inputted. Then, a first subtraction operation of subtracting the absolute value of the first operand from the absolute value of the second operand and a second subtraction operation of subtracting the absolute value of the second operand from the absolute value of the first operand are carried out in parallel. In a case where overflow occurs during a process of subtraction in a subtraction circuit that carries out the first subtraction operation, the overflow is detected, a carry signal is generated, and the corrected one of the first subtraction result and the second subtraction result is selected using the carry signal. Thus, it is possible to always obtain the correct solution for any combination of operands at one time of subtraction, and thus, it is possible to improve the efficiency of a subtractor.

For example, Japanese Laid-Open Patent Application No. S54-054542, Japanese Laid-Open Patent Application No. S59-201144 and Japanese Laid-Open Patent Application No. H01-086238 discuss the related art.

### SUMMARY

According to one aspect of the embodiments, a decimal absolute value adder includes a first arithmetic circuit that adds two operands and output a first arithmetic operation result; a second arithmetic circuit that adds the two operands to 10 and outputs a second arithmetic operation result; a third arithmetic circuit that adds the two operands to 6 and outputs a third arithmetic operation result; a fourth arithmetic circuit that adds the two operands to 1 and outputs a fourth arithmetic operation result; a fifth arithmetic circuit that adds the two operands to 11 and outputs a fifth arithmetic operation result; a sixth arithmetic circuit that adds the two operands to 7 and outputs a sixth arithmetic operation result; and a selection circuit that selects any one of the first arithmetic operation result, the second arithmetic operation result, the fourth arithmetic operation result and the fifth arithmetic operation result in a case where an arithmetic operation of the two operands is an addition of numbers having identical signs or in a case where an arithmetic operation of the two operands is an addition of two numbers having different signs and has an arithmetic operation result that is not negative, selects a 1's complement of any one of the first arithmetic operation result, the third arithmetic operation result, the fourth arithmetic operation result and the sixth arithmetic operation result in a case where an arithmetic operation of the two operands is an addition of two numbers having different signs and has an arithmetic operation result that is negative, and outputs a decimal absolute value addition result.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 depicts correspondence relationships between BCD (Binary Coded Decimal) codes and decimal numbers;

FIG. 2 is a block diagram depicting one example of the entire configuration of a decimal absolute value adder applicable to a first embodiment or a second embodiment;

FIG. 3 is a block diagram depicting another example of the entire configuration of a decimal absolute value adder applicable to the first embodiment or the second embodiment;

FIG. 4 is a block diagram depicting one example of a configuration of a decimal absolute value adder body (“decimal absolute adder”) depicted in FIG. 2 or FIG. 3;

FIG. 5 depicts one example of a circuit configuration of a 9's complement circuit (“9's component”) depicted in FIG. 2;

FIG. 6 is a block diagram depicting another example of a configuration of a decimal absolute value adder body (“decimal absolute adder”) depicted in FIG. 2 or FIG. 3;

FIG. 7 depicts one example of a circuit configuration of a BCD correction circuit (“BCD adjust”) depicted in FIG. 4 or FIG. 6;

FIG. 8 is a block diagram depicting a configuration of a decimal absolute value adder body according to the first embodiment;

FIG. 9 is a block diagram depicting one example of an internal configuration of a segment absolute value adder (an absolute value adder for one digit of a decimal number) depicted in FIG. 8;

FIG. 10 is a block diagram depicting one example of a configuration of a block carry propagation circuit (“Block carry propagate”) of FIG. 8 of a case where the block carry propagation circuit is formed using two binary carry look ahead circuits respectively generating “block carry in” signals at a time of re-complement (BCin for recomp) and “block carry in” signals at a time of not carrying out re-complement (BCin for non-recomp) depicted in FIG. 9:

FIG. 11 is a circuit diagram depicting one example of a circuit configuration of a 4 bit adder (A+B) depicted in FIG. 9;

FIG. 12 is a circuit diagram depicting one example of a circuit configuration of a 4 bit adder (A+B+1) depicted in FIG. 9;

FIG. 13 is a circuit diagram depicting one example of a circuit configuration of a 4 bit adder (A+B+6) depicted in FIG. 9;

FIG. 14 comparatively depicts bit patterns of operation results of low four bits for respective cases of adding “6” (D+6) and subtracting “10” (D−10) for numbers each expressed by four bits;

FIG. 15 depicts the contents of carry and borrow generated from the respective bits in the circuit example of FIG. 13;

FIG. 16 is a circuit diagram depicting one example of a circuit configuration of a 4 bit adder (A+B+7) depicted in FIG. 9;

FIG. 17 depicts the contents of carry and borrow generated from the respective bits in the circuit example of FIG. 16;

FIG. 18 is a circuit diagram depicting one example of a circuit configuration of a 4 bit adder (A+B+10) depicted in FIG. 9;

FIG. 19 depicts the contents of carry and borrow generated from the respective bits in the circuit example of FIG. 18;

FIG. 20 is a circuit diagram depicting one example of a circuit configuration of a 4 bit adder (A+B+11) depicted in FIG. 9;

FIG. 21 depicts the contents of carry and borrow generated from the respective bits in the circuit example of FIG. 20;

FIG. 22 is a block diagram depicting one example of an internal configuration of each of segment absolute value adders (absolute value adders each for four digits of a decimal number in the case of the second embodiment) according to the second embodiment;

FIG. 23 is a block diagram depicting one example of an internal configuration of an absolute value adder for one digit of a decimal number (“digit adder block”) depicted in FIG. 22;

FIG. 24 is a block diagram depicting one example of an internal configuration of an absolute value adder for one digit of a decimal number (“digit adder block”, i.e., the segment absolute value adder depicted in FIG. 8) according to a third embodiment; and

FIG. 25 is a block diagram depicting one example of the entire configuration of a decimal absolute value adder according to the third embodiment.

### DESCRIPTION OF EMBODIMENTS

Below, the embodiments will be described in detail.

First, an absolute value adder will be described. A binary absolute value adder is an arithmetic circuit carrying out the following operations. That is, at a time of subtraction (i.e., addition of numbers having different signs), the 2's complement of the subtrahend is added to the minuend. In a case where the subtraction result is negative, the absolute value of the subtraction result is obtained by obtaining the 2's complement of the addition result. Obtaining the 2's complement in such a case is referred to as “re-complement”.

A decimal absolute value adder is an arithmetic circuit carrying out the following operations. That is, at a time of subtraction (i.e., addition of numbers having different signs), the 10's complement of the subtrahend is added to the minuend. In a case where the subtraction result is negative, the absolute value of the subtraction result is obtained by obtaining the 10's complement of the addition result. Obtaining the 10's complement in such a case is referred to as “re-complement”.

The first embodiment has the following feature.

(1) The first embodiment is a decimal absolute value adder which carries out calculation of numerical values expressed by BCD (Binary Coded Decimal).

(2) By realizing the decimal adder using high-speed binary adders, it is possible to realize a high-speed decimal absolute value adder.

(3) Upon realizing the high-speed decimal absolute value adder, a circuit is provided which obtains partial sums corresponding to A+B, A+B+1, A+B+6, A+B+7, A+B+10 and A+B+11 in digit units of binary adders. The term “digit” means one digit of a decimal number (i.e., 4 bits in BCD code). “A” and “B” denote operands in digit units, respectively. Thus, the partial sum means a sum of digit unit.

(4) At a time of addition (addition of numbers having identical signs), the operation result is obtained using any one of A+B, A+B+1, A+B+10 and A+B+11 depending on the carry conditions.

(5) At a time of subtraction (addition of numbers having different signs), when the result will be positive, the operation result is obtained using any one of A+B, A+B+1, A+B+10 and A+B+11 depending on the carry conditions. On the other hand, when the result will be negative, the operation result is obtained using the 1's complement of any one of A+B, A+B+1, A+B+6 and A+B+7 depending on the carry condition, and thus the absolute value is obtained. That is, the absolute value of the negative subtraction result is obtained.

(6) It is possible to obtain the partial sum corresponding to any one of the above-mentioned A+B+6, A+B+7, A+B+10 and A+B+11 by a size and a speed nearly equal to those of a common CLA (Carry Look Ahead) type 4 bit adder.

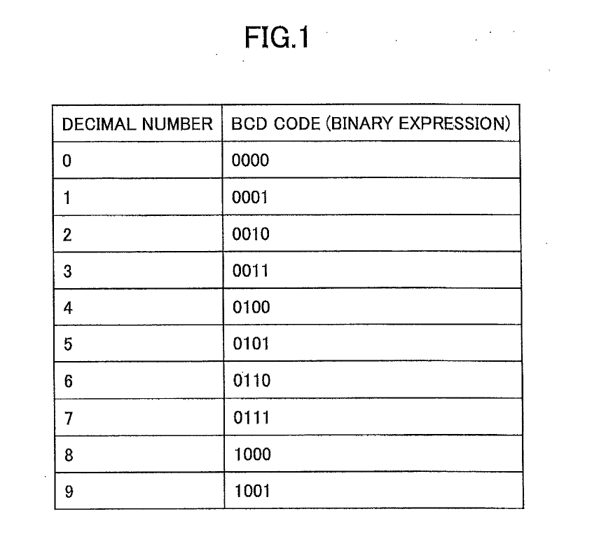

For reference, FIG. 1 depicts correspondence relationships between binary expressions of BCD code and decimal numbers.

A method of realizing a decimal adder using high-speed binary adders according to the first embodiment will now be described.

At a time of addition (i.e., addition of numbers having identical signs), previously “+6” is carried out on each digit of one operand. Thus, carry is made to propagate among the digits of high-speed binary adders. That is, by mapping 9 (1001 in binary expression) to 15 (1111 in binary expression), carry of a digit of a binary adder can be made to be 1 when 1 has been added.

In this method, in a case where no carry is generated from a digit, the removal of the above-mentioned +6 is not achieved, and thus, the operation result includes the surplus +6. Therefore, in a case where no carry is generated from a digit, “−6” is carried out on the digit of the operation result, and thus, the BCD code is obtained.

At a time of subtraction (i.e., addition of numbers having different signs), the 1's complement of the subtrahend operand is obtained. This operation is equivalent to operation of obtaining the 9's complement of each digit of the subtrahend operand and after that carrying out “+6”. Then, in the high-speed binary adder, the lowest Cin (i.e., “carry in” corresponding to carry generated from the low digit) input is made to be 1, and the above-mentioned 1's complement of the subtrahend operand is added to the minuend operand. The above-mentioned the lowest Cin input being made to be 1 is thus carried out for the purpose of obtaining the 10's complement of the above-mentioned 9's complement. The same as the above-mentioned time of addition, the above-mentioned +6 is surplus in a case where no carry is generated from the digit. Therefore, in a case where no carry is generated from the digit, “−6” is carried out on the resulting digit, and the BCD code is obtained. That is, at a time of subtraction, the same operation as that of a time of addition is carried out after the complement (10's complement) of the subtrahend operand is previously generated.

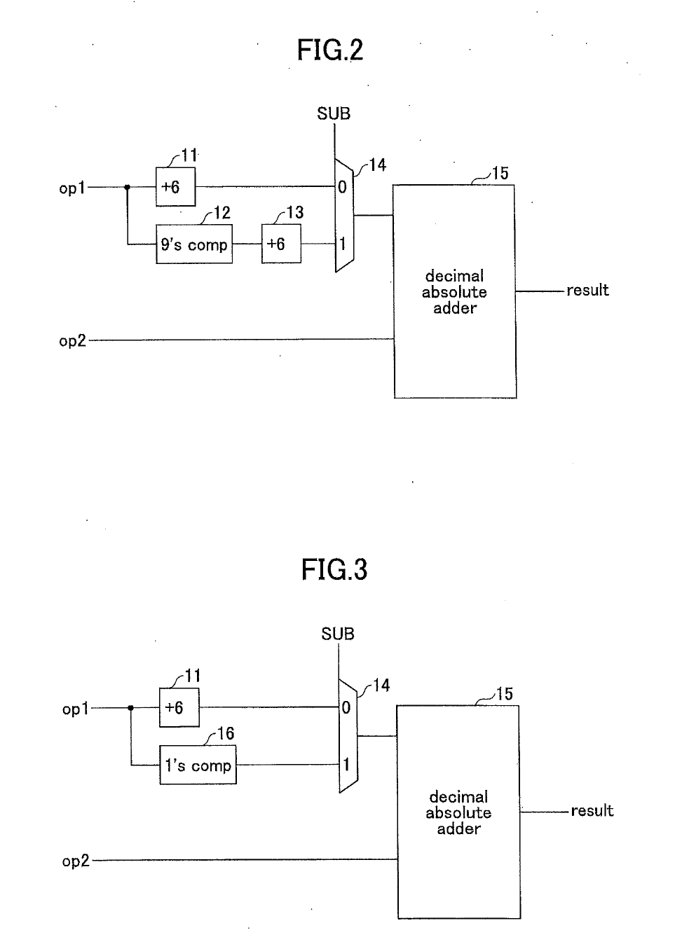

FIG. 2 depicts one example of the entire configuration of a decimal absolute value adder of a type using high-speed binary adders, including a part carrying out preprocessing correction. Further, FIG. 3 depicts one example of the entire configuration of a case obtaining the 1's complement, instead of carrying out “+6” after obtaining the 9's complement.

The decimal absolute value adder depicted in FIG. 2 includes an addition circuit 11 carrying out “+6” on each digit of the first operand op1, a 9's complement circuit 12 obtaining the 9's complement of each digit of the first operand op1, and an addition circuit 13 carrying out “+6” after thus obtaining the 9's complement. The decimal absolute value adder further includes a selector 14 selecting any one of the respective outputs of the addition circuit 11 and the addition circuit 13, and a decimal absolute value adder body (“decimal absolute adder”) 15. The addition circuit 11, the 9's complement circuit 12, the addition circuit 13 and the selector 14 are the above-mentioned part carrying out preprocessing correction. The selector 14 selects the output of the addition circuit 11 in a case where a signal SUB has “1”, and outputs the selected output to the decimal absolute value adder body 15. The SUB signal is a signal having “1” in a case where the current operation is subtraction and having “0” in a case where the current operation is addition. In a case where the signal SUB has “1”, the selector 14 selects the output of the addition circuit 13, and outputs the selected output to the decimal absolute value adder 15. The decimal absolute value adder 15 carries out decimal absolute value addition of the output value of the selector 14 and the second operand op2, and outputs the decimal absolute value addition result “result”.

The decimal absolute value adder depicted in FIG. 3 includes the same configuration as that of the decimal absolute value adder depicted in FIG. 2, the same reference numerals are given to the same parts, and duplicate description will be omitted. The decimal absolute value adder depicted in FIG. 3 has a 1's complement circuit 16 obtaining the 1's complement of each digit of the first operand op1, instead of the 9's complement circuit 12 and the addition circuit 13.

In the entire configuration of the decimal absolute value adder depicted in FIG. 2 or FIG. 3, it is possible to apply known techniques to the addition circuit 11 carrying out “+6” at a time of addition, and the 9's complement circuit 12 and the addition circuit 13 (or the 1's complement circuit 16) obtaining the 9's complement and carrying out “+6” at a time of subtraction.

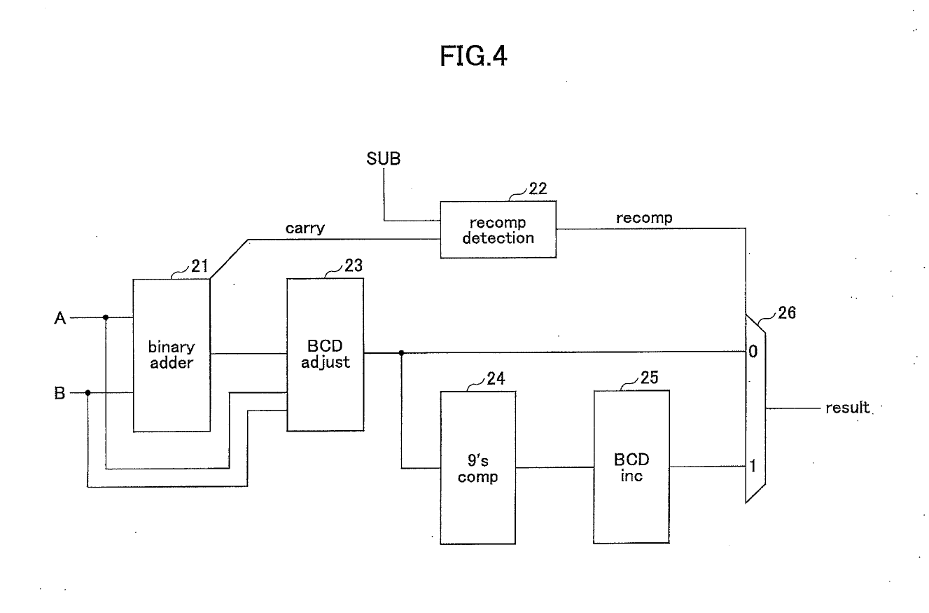

FIG. 4 depicts one example of a configuration of the decimal absolute value adder body 15 included in the entire configuration of the decimal absolute value adder depicted in FIG. 2 or FIG. 3

The decimal absolute value adder body of the example depicted in FIG. 4 includes a binary adder 21, a re-complement detection circuit (“recomp detection”) 22, a BCD correction circuit (“BCD adjust”) 23, a 9's complement circuit (“9's comp”) 24, a BCD increment circuit (“BCD inc”) 25 and a selector 26. In FIG. 4, an input A of two inputs A and B is the result of carrying out, on the first operand op1 depicted in FIG. 2 or FIG. 3, the processing carried out by the addition circuit 11 or the 9's complement circuit 21 and the addition circuit 13, or the processing carried out by the addition circuit 11 or the 1's complement circuit 16. On the other hand, the input B is the second operand op2 depicted in FIG. 2 or FIG. 3. It is noted that A and B are logically replaceable equivalent values, and thus, A and B may be replaced with one another.

The re-complement detection circuit 22 determines whether re-complement will be carried out on the addition result of the binary adder 21, outputs “1” to the selector 26 in a case of carrying out re-complement, and outputs “0” to the selector 26 in a case of not carrying out re-complement. To the re-complement detection circuit 22, the carry output signal “carry” from the binary adder 21 and the signal SUB are inputted. The signal SUB indicates whether the current operation that is carried out on the first operand op1 and the second operand op2 is subtraction (i.e., addition of numbers having different signs, the same manner being applied hereinafter). The re-complement detection circuit 22 outputs “0” in a case where the signal SUB indicates “addition” (i.e., addition of numbers having identical signs, the same manner being applied hereinafter) regardless of the value of the carry output signal “carry”. On the other hand, in a case where the SUB signal indicates “subtraction”, the re-complement detection circuit 22 outputs “0” in a case where the carry output signal “carry” is “1” (at a time of the subtraction result being positive, and thus, re-complement not being carried out), and outputs “1” in a case where the carry output signal “carry” is “0” (at a time of the subtraction result being negative, and thus, re-complement being carried out).

Thus, the re-complement detection circuit 22 outputs “0” in a case of the current operation being addition. The re-complement detection circuit 22 outputs “0” in a case of the current operation being subtraction, the subtraction result being positive and thus re-complement being not carried out. The re-complement detection circuit 22 outputs “1” in a case of the current operation being subtraction, the subtraction result being negative and thus re-complement being carried out. According to the output signal of the re-complement detection circuit 22, the selector 26 outputs the output value of the BCD correction circuit 23 in a case where the current operation is addition. Also, the selector 26 outputs the output value of the BCD correction circuit 23 in a case where the current operation is subtraction, the subtraction result is positive and thus, re-complement will not be carried out. On the other hand, the selector 26 outputs the output value of the BCD increment circuit 25 in a case where the current operation is subtraction, the subtraction result is negative and thus, re-complement will be carried out.

The decimal absolute value adder body depicted in FIG. 4 carries out the following processing in a case where the current operation that is carried out on the first operand op1 and the second operand op2 is addition (i.e., addition of numbers having identical signs). That is, the binary adder 21 adds the number A obtained from carrying out “+6” by the addition circuit 11 depicted in FIG. 2 or FIG. 3 on each digit of the number of BCD code (the operand op1) and the number B of BCD code (the operand op2) together as binary numbers.

As mentioned above, the selector 26 selects the output of the BCD correction circuit 23 and outputs it in a case where the current operation that is carried out on the first operand op1 and the second operand op2 is addition (i.e., addition of numbers having identical signs). The BCD correction circuit 23 carries out, on the output of the binary adder 21, in each digit, correction of carrying out “−6” in a case where the surplus “+6” is included as mentioned above, and the output value is inputted to the selector 26. The decimal absolute value addition result “result” thus obtained from the BCD correction circuit 23 is then outputted from the selector 26.

On the other hand, in a case where the current operation that is carried out on the first operand op1 and the second operand op2 is subtraction (i.e., addition of numbers having different signs), the following processing is carried out on the input data A and B. In this case, the input data A of FIG. 4 is data obtained from obtaining the 9's complement of each digit of the number of BCD code (the operand op1) and then carrying out “+6” by the 9's complement circuit 12 and the addition circuit 13 depicted in FIG. 2 or obtaining the 1's complement of each digit of the number of BCD code (the operand op1) by the 1's complement circuit 16 depicted in FIG. 3. The input data B is the BCD code (the operand op2). The binary adder 21 adds the input data A and B together as binary numbers. It is noted that in this case, in order to obtain the 10's complement from the 9's complement as mentioned above, the above-mentioned addition is carried out while the lowest Cin input (not depicted in FIG. 4) is made to be 1 in the binary adder 21.

Then, in a case where the current operation that is carried out on the first operand op1 and the second operand op2 is subtraction and the subtraction result will not be negative, the selector 26 selects the output of the BCD correction circuit 23 and outputs it, as mentioned above. The BCD correction circuit 23 carries out, on the output value of the binary adder 21, in each digit, correction of carrying out “−6” in a case where the surplus +6 is included as mentioned above, and the output value is inputted to the selector 26. The decimal absolute value addition result “result” thus obtained from the BCD correction circuit 23 is then outputted from the selector 26.

On the other hand, in a case where the current operation that is carried out on the first operand op1 and the second operand op2 is subtraction and the subtraction result will be negative (for carrying out re-complement), the selector 26 selects the output of the BCD increment circuit 25 connected to the 9's complement circuit 24, and outputs it. In this case, the 9's complement circuit 24 obtains the 9's complement of each digit of the output value of the BCD correction circuit 23, and further, the BCD increment circuit 25 obtains the 10's complement by adding 1 to each digit of the output value of the 9's complement circuit 24. The decimal absolute value addition result “result” thus obtained from the BCD increment circuit 25 is then outputted from the selector 26.

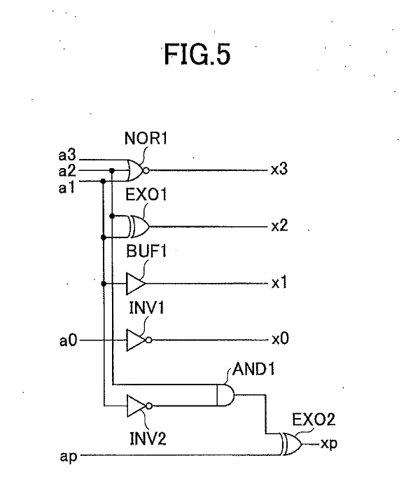

FIG. 5 depicts one example of a circuit configuration of each of the above-mentioned 9's complement circuits 12 and 24. The 9's complement circuit of FIG. 5 includes a negative OR (hereinafter, simply referred to as NOR) circuit NOR1, an exclusive OR (hereinafter, simply referred to as EXOR) circuit EXO1, a buffer BUF1, a logical product (hereinafter, simply referred to as AND) circuit AND1, an inverter INV1 and an EXOR circuit EXO2.

To the 9's complement circuit of FIG. 5, the first to fourth bits a3, a2, a1 and a0 of BCD code of one digit, and a parity bit ap are inputted. The 9's complement circuit obtains the 9's complement of BCD code, and outputs the first to fourth bits x3, x2, x1 and x0, and a parity bit xp. That is, a3, a2 and a1 are inputted to the NOR circuit NOR1 which then outputs x3. The bits a2 and a1 are inputted to the EXOR circuit EXO1 which outputs x2. The bit a1 is inputted to the buffer BUF1 which outputs x1. The bit a0 is inputted to the inverter INV1 which outputs x0. The bit a2 and the bit inverted from a1 by the inverter INV1 are inputted to the AND circuit AND1. The EXOR circuit EXO2 carries out exclusive OR operation on the output of the AND circuit AND1 and ap, and outputs xp.

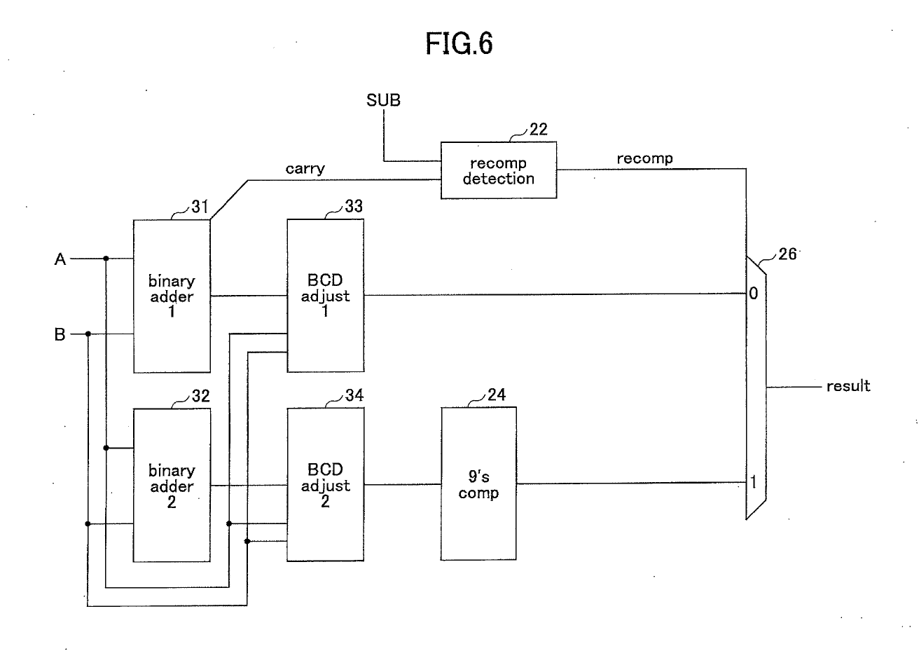

FIG. 6 depicts another example of the decimal absolute value adder body described above using FIG. 4. The example of FIG. 6 is an example in which, in consideration of the processing carried out by the BCD increment circuit 25 taking a longer time in a case where the number of digits of a decimal number processed by the decimal absolute value adder is increased, the BCD increment circuit is omitted.

In the example of FIG. 6, in a case where the current operation is addition, a binary adder 31, a BCD correction circuit (“BCD adjust 1) 33 and a re-complement circuit 22 correspond to the binary adder 21, BCD correction circuit 23 and re-complement circuit 22 in the example of FIG. 4, respectively, and have the same functions, respectively. That is, the binary adder 31 adds the number A obtained from carrying out “+6” on each digit of the number of BCD code (the operand op1) by the addition circuit 11 depicted in FIG. 2 or FIG. 3 and the number B of BCD code (the operand opt) together as binary numbers. The BCD correction circuit 33 then carries out, in each digit, correction of carrying out “−6” in a case where the surplus +6 is included as mentioned above, and the output value thereof is inputted to the selector 26. The decimal absolute value addition result “result” thus obtained from the BCD correction circuit 33 is then outputted from the selector 26.

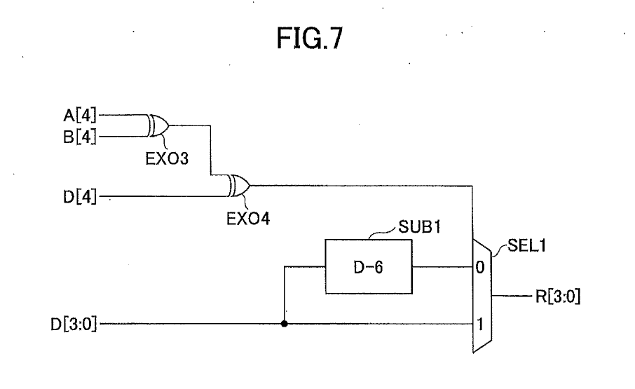

FIG. 7 depicts one example of a circuit configuration of each of the BCD correction circuits 23, 33 and 34 for one digit. The BCD correction circuit of FIG. 7 includes EXOR circuits EXO3 and EXO4, a subtraction circuit SUB1 and a selector SEL1. The EXOR circuit EXO3 obtains EXOR of A[4] and B[4] which are respective bits immediately above one digit of input data A and B. In a case where the bits corresponding to A[4] and B[4] do not exist, they are assumed as “0”. The EXOR circuit EXO4 obtains EXOR of the output of EXO3 and D[4] that is one bit immediately above the digit of the output D of the binary adder. In a case where the bit corresponding to D[4] does not exist, the carry output of the binary adder that outputs D is used instead. As a result, in a case where no carry is generated from the operation result of A+B, EXO4 outputs 0. In a case where carry is generated from the operation result of A+B, EXO4 outputs 1. The selector SEL1 selects the output value of the subtraction circuit SUB1 and outputs it (correction of “−6” being carried out) in a case where no carry is generated from the operation result of A+B (“0”). The selector SEL1 selects D and outputs it (correction of “−6” being not carried out) in a case where carry is generated from the operation result of A+B (“1”).

Returning to the description of FIG. 6, in a case where the current operation is subtraction, the input data A and B of FIG. 6 is processed as follows. That is, the input data A is data obtained from obtaining the 9's complement of each digit of the number of BCD code (the operand op1) and then carrying out “+6” by the 9's complement circuit 12 and the addition circuit 13 depicted in FIG. 2 or obtaining the 1's complement of each digit of the number of BCD code (the operand op1) by the 1's complement circuit 16 depicted in FIG. 3. The input data B is the BCD code (the operand op2). The input data A and B are added together as binary numbers by the binary adder 31. It is noted that in this case, in order to obtain the 10's complement from the 9's complement as mentioned above, the above-mentioned addition is carried out while the lowest Cin input (not depicted in FIG. 6) is made to be 1 in the binary adder 31.

Then, in a case where the current operation that is carried out on the first operand op1 and the second operand op2 is subtraction and the subtraction result will not be negative, the selector 26 selects the output of the BCD correction circuit 33 and outputs it as mentioned above. The BCD correction circuit 33 carries out, for each digit of the output of the binary adder 31, correction of carrying out “−6” in a case where surplus +6 is included as mentioned above, and the output value is inputted to the selector 26. The decimal absolute value addition result “result” thus obtained from the BCD correction circuit 33 is then outputted from the selector 26.

On the other hand, in a case where the current operation that is carried out on the first operand op1 and the second operand opt is subtraction and the subtraction result will be negative (for carrying out re-complement), the selector 26 selects the output of the 9's complement circuit 24, and outputs it. In this case, as depicted in FIG. 6, to the 9's complement circuit 24, the output value of the binary adder 32 is inputted after passing through the BCD correction circuit (“BCD adjust 2”) 34. In this case, in the binary adder 32, the lowest Cin input is made to be 0, and addition of the binary numbers is carried out, and the addition result is inputted to the BCD correction circuit 34. Then, the 9's complement circuit 24 obtains the 9's complement of the output of the BCD correction circuit 34, and the thus obtained decimal absolute value addition result “result” is outputted from the selector 26. In this case, as mentioned above, in the binary adder 32, the lowest Cin input is made to be 0, and the addition of the binary numbers is carried out. Thus, different from the example of FIG. 4, the processing of “+1” by the BCD increment circuit is unnecessary. As a result, the BCD increment circuit is unnecessary. Further, in the case where the current operation is subtraction in the example of FIG. 6, the binary adders 31 and 32 carry out the addition processing in parallel, and also, the BCD correction circuits 33 and 34 carry out the correction processing in parallel. Thus, it is possible to reduce the processing time.

As an example of a configuration of a decimal adder in digit units, an example discussed in Japanese Laid-Open Patent Application No. 554-054542 will now be described. In this example, two signal lines only depending on Cout that is carry of a digit itself and four signal lines depending on both Cin that is carry generated from the outside and the above-mentioned Cout are provided in parallel. Then, logical AND is carried out between the conditions of the total six signal lines and the conditions of the above-mentioned Cin or Cout, respectively, and logical OR is carried out between the respective results of the logical AND. Thus, BCD correction processing is improved in its speed. According to the configuration example of Japanese Laid-Open Patent Application No. S54-054542, the result of A+B+Cin and the result obtained from decimal correction (processing of “−6”) thereof are selected by the carry signal (Cin) from the outside and the carry signal (Cout) of the digit itself. Further, these Cin signal and the Cout signal are produced by a known carry look ahead circuit. Also, the Cout signal will be equivalent to the Cin signal for a high digit. Therefore, both the Cin signal and the Cout signal will drive two digits. Further, by transforming a logical formula, the logical AND of the Cin signal and the Cout signal is made to be carried out at the last stage. Then, by utilizing a fact that the wired OR logic can be used, the logical OR is carried out on many signals collectively at once, and thus, the processing is improved in its speed.

Further, as a method of obtaining an absolute value of a result of decimal subtraction, technologies discussed in Japanese Laid-Open Patent Application No. S59-201144 and Japanese Laid-Open Patent Application No. H01-086238 exist. However, in any technology, two sets of adders or subtractors are used, and operations of A−B and B−A are carried out thereby in parallel. According to Japanese Laid-Open Patent Application No. S59-201144, the two operation results are stored in registers and then, selection is carried out.

In the respective configurations of FIGS. 4 and 6 described above, the BCD correction is carried out on the addition result of the binary adder. Thus, a time may be taken for the operation processing. Furthermore, at a time of subtraction, a processing time for obtaining the 9's complement is taken.

Further, in the example of FIG. 4, the processing by the BCD increment circuit 25 is carried out at a time of subtraction, and as the number of digits increases, a longer time is taken for the subtraction processing.

Further, in a configuration of carrying out the addition processing by the binary adder, the correction processing by the BCD correction circuit and the re-complement processing in sequence, there is an advantage. That is, there is a case where a semiconductor manufacturer prepares a high-speed binary adder in an IP (Intellectual Property) core since a binary adder is a widely used functional circuit. If so, the high-speed binary adder can be used in the above-mentioned configuration. However, the processing time may be increased by the decimal correction and the re-complement.

Further, according to the method discussed in Japanese Laid-Open Patent Application No. 554-054542, the Cin signal and Cout signal are obtained from the external carry look ahead circuit. Thus, the number of critical paths increases to two for Cin and Cout although originally the critical path is only for Cin. Furthermore, the Cout signal will be equivalent to the Cin signal for a higher digit. Thus, both the Cin signal and the Cout signal will drive two digits, and thus, the load is increased. As a result, the time taken for generating the Cin signal and the Cout signal as carry propagation signals for which a time is taken may be further increased. Further, the number of operation results which is originally 4 is intentionally increased to 6 so as to reduce the number of stages used for generating the respective signals. Then, the processing is improved in its speed depending on the wired OR logic. Therefore, for a device such as a static CMOS for which the wired logic is not available, a time is taken for carrying out the logical OR on many signals. As a result, the time taken for carrying out the logical operation of the Cin/Cout signals provided from the outside may be increased. Further, in the method of carrying out the decimal correction after the operation result is obtained, the processing of the path carrying out the decimal correction may take a time.

Further, in the method of using the two sets of adders for subtraction as discussed in Japanese Laid-Open Patent Application No. 559-201144 and Japanese Laid-Open Patent Application No. H01-086238, the circuit size may be increased. Further, in the case of the configuration of Japanese Laid-Open Patent Application No. S59-201144, the amount of material for the registers may be doubled.

According to the first embodiment, in consideration of these situations, it is possible to provide a decimal absolute value adder by which it is possible to effectively reduce a time taken for operation processing.

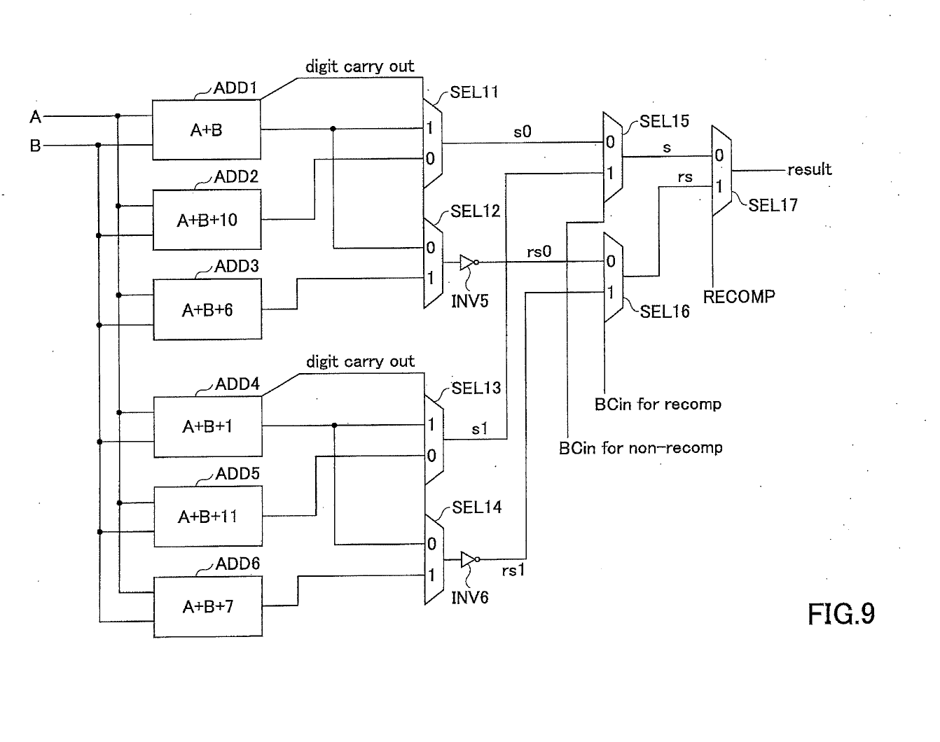

According to the first embodiment, as digit arithmetic circuits in an adder of digit unit using binary adders, adders ADD1, ADD2, ADD3, ADD4, ADD5 and ADD6 are provided which carry out respective operations of +B, A+B+10, A+B+6, A+B+1, A+B+11 and A+B+7 in parallel, as depicted in FIG. 9 described later. In these adders ADD1, ADD2, ADD3, ADD4, ADD5 and ADD6, the adders ADD1, ADD2 and ADD3 carrying out A+B, A+B+10 and A+B+6, respectively, generate an operation result for a case where no carry is generated from the low digit. On the other hand, the adders ADD4, ADD5 and ADD6 carrying out A+B+1, A+B+11 and A+B+7 generate an operation result for a case where carry is generated from the low digit.

An operation result for a case where re-complement is not carried out on the operation result and no carry is generated from the low digit is calculated by the adder ADD1 of A+B and the adder ADD2 of A+B+10. Then, based on carry output signal “digit carry out” of the adder ADD1 of A+B, whether BCD correction will be carried out is determined. The BCD correction means, for example, correction of carrying out “−6” carried out by the BCD correction circuit 23, 33 or 34 described above using FIGS. 4, 6, 7, and so forth. In a case where BCD correction is not carried out, the operation result of the adder ADD1 of A+B is used (s0). In a case where BCD correction is carried out, the operation result of the adder ADD2 of A+B+10 is used (s0). It is noted that 10 is a 16's complement of 6. Therefore, A+B+10 is equivalent to A+B−6 in a calculation closed within 4 bits. Thus, in a case where the BCD correction (−6) is carried out, the adder ADD2 of A+B+10 is used.

Further, an operation result for a case where re-complement is not carried out and carry is generated from the low digit is calculated by the adder ADD4 of A+B+1, i.e., adding 1 to A+B, and the adder ADD5 of A+B+11, i.e., adding 1 to A+B+10, in consideration of +1 of carry. Also in this case, the same as the above-mentioned case of no carry generated from the low digit, based on the carry output signal “digit carry out” of the adder ADD4 of A+B+1, whether the BCD correction will be carried out is determined. In a case where the BCD correction will not be carried out, the operation result of the adder ADD4 of A+B+1 is used (s1). In a case where the BCD correction will be carried out, the operation result of the adder ADD5 of A+B+11 is used (s1).

Thus, according to the method of the first embodiment, determination as to whether the BCD correction will be carried out is completed within the digit, and thus, the processing can be carried out within a delay time taken for carrying out “carry look ahead” merely for 4 bits. Thus, it is possible to improve the processing speed.

Further, in the process of obtaining a complement for re-complement, the 9's complement will be obtained for carrying out decimal operation using BCD code. One example of the 9's complement circuit is one depicted in FIG. 5. In the case of FIG. 5, the 3-input NOR circuit NOR1 generating x3 and EXOR circuit EXO1 generating x2 are gates taking a relatively long operation time. Further, in the example of FIG. 5, the obtaining the complement is accompanied by estimating the parity of the digit which includes the three stages of gates, i.e., the inverter INV2, AND circuit AND1 and EXOR circuit EXO2.

In contrast thereto, in the configuration according to the first embodiment depicted in FIG. 9 (described later), one stage of inverters INV5 and INV6 are used for generating the operation results rs0 and rs1, as a 1's complement circuit for obtaining the 1's complement, instead of the circuit taking a relatively long time as in FIG. 5. Thus, the processing speed is improved. The parity for the digit is not changed when obtaining the 1's complement. Thus, it is not necessary to modify the operation result for obtaining the change of the parity. Thus, it is possible to improve the speed of the operation.

Here, “r” (0≦r≦9) denotes an operation result of BCD code before re-complement in a case where re-complement will be carried out. It is noted that in the above-mentioned preprocessing, previously “+6” is carried out (by the adder 13 of FIG. 2, for example). Thus, the operation result of the adder ADD1 of A+B is “r+6” in a case where the value of the carry output signal “digit carry out” (COUT) of the digit is such as COUT=0 (i.e., +6 is surplus), and “r” in a case of COUT=1. Further, operation of obtaining the 1's complement in the digit is equivalent to operation of subtracting the number from 15. Thus, when the 1's complement of the operation result of A+B is obtained, “15−(r+6)=(9−r)” will be obtained at a time of COUT=0. On the other hand, “15−r=(9−r)+6” will be obtained at a time of COUT=1. Thus, at a time of COUT=0, “(9−r)” can be obtained, which is equivalent to the case of obtaining the 9's complement, after the 1's complement of the operation result of A+B has been thus obtained. On the other hand, at a time of COUT=1, “(9−r)+6” is obtained, in which 6 is surplus for the 9's complement (9−r), after the 1's complement of the operation result of A+B has been thus obtained. Therefore, in this case, such a configuration will be provided that the surplus 6 will not be included after the operation result has been subtracted from 15. That is, the adder ADD3 of A+B+6 is used by which 6 is previously added to A+B so that “15−(r+6)” will be obtained after the operation result has been subtracted from 15.

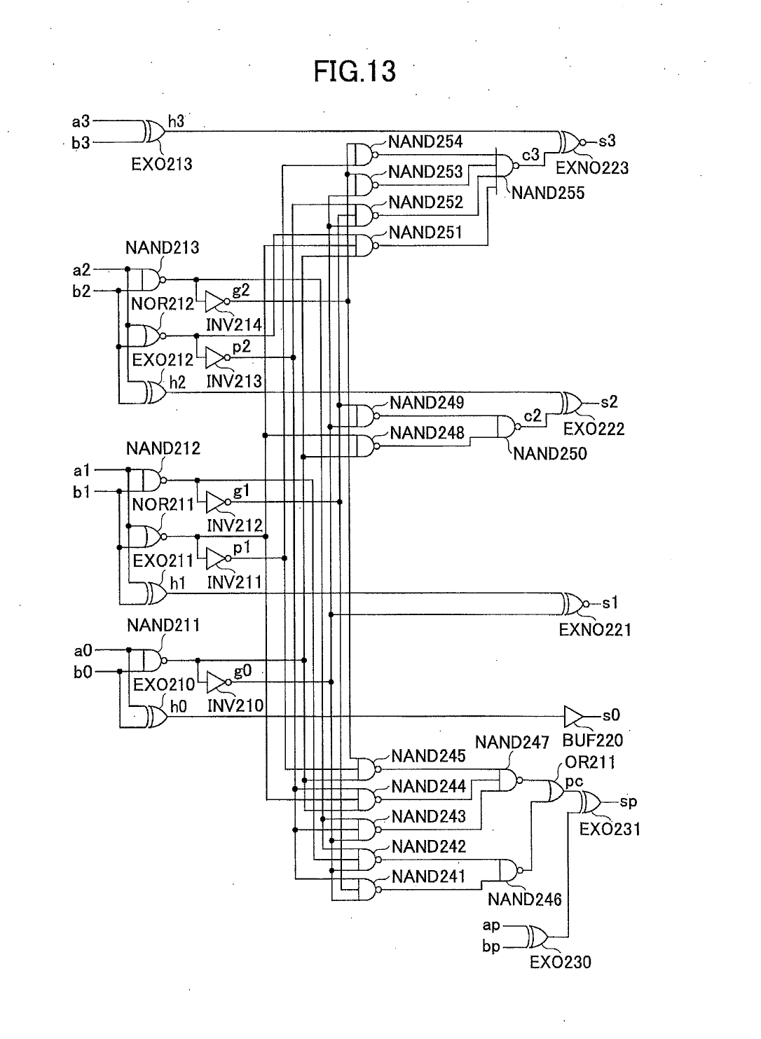

Here, in the case of adding three values together such as A+B+6, it is possible to employ a method of using adders connected together in series in two stages, or using a CSA (Carry Save Adder) and an adder connected together in series in two stages. However, in these methods, a surplus processing time is taken in comparison to the operation of A+B. Therefore, according to the first embodiment, a configuration of a 4 bit CLA (Carry Look Ahead) adder is applied as the adder ADD3 of A+B+6. A specific circuit configuration example thereof is depicted in FIG. 13 (described later). In the configuration, the fact that one of the three operands has a fixed value (in the case of A+B+6, “6” is the fixed value) in the adding three values together. Thus, according to the first embodiment, it is possible to carry out the operation of A+B+6 in a processing time equal to the processing time taken for the operation of A+B.

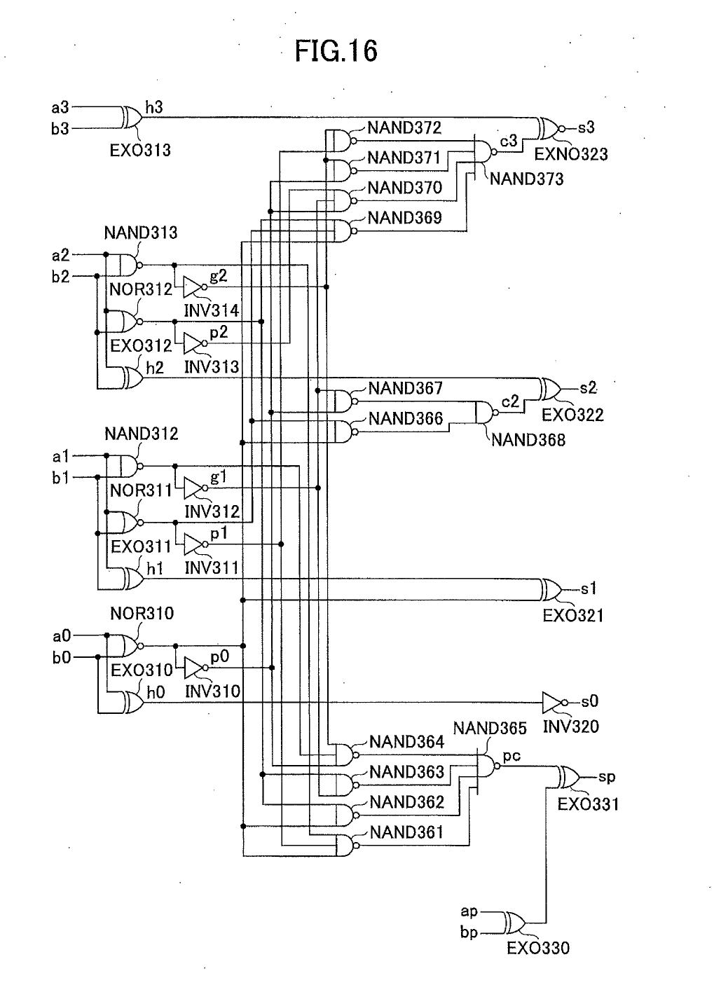

Further, in the configuration of FIG. 9, the adder ADD4 of A+B+1 is used instead of the adder ADD1 of A+B in a case where the external carry input is “1”. Similarly, instead of the adder ADD3 of A+B+6, the adder ADD6 of A+B+7 (=(A+B+1)+6) (see FIG. 16) that is a high-speed adder the same as the adder ADD3 of A+B+6 is used.

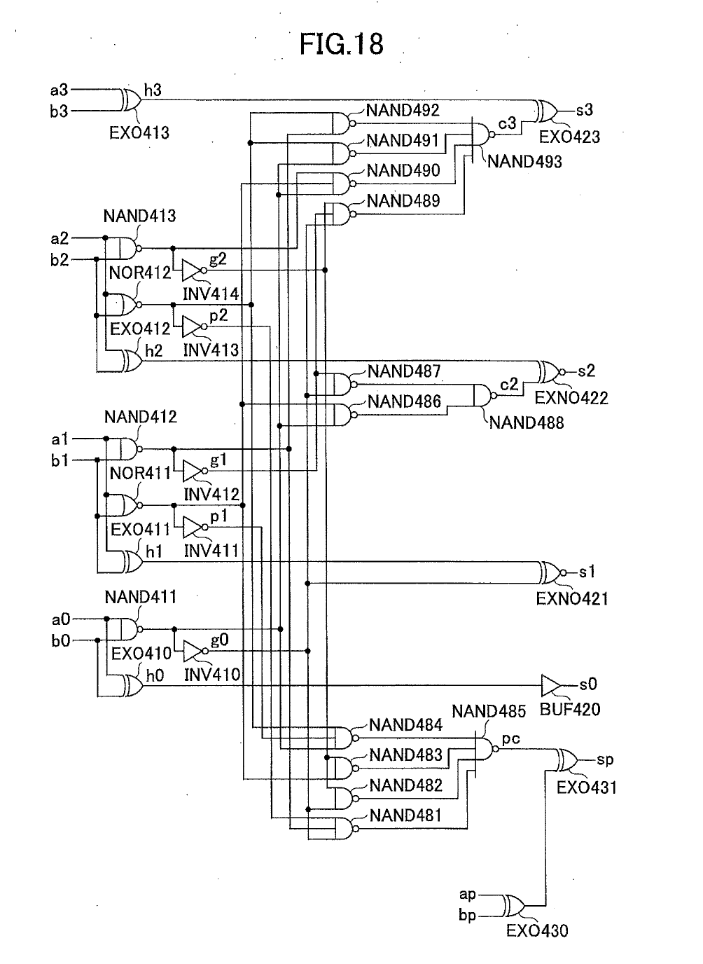

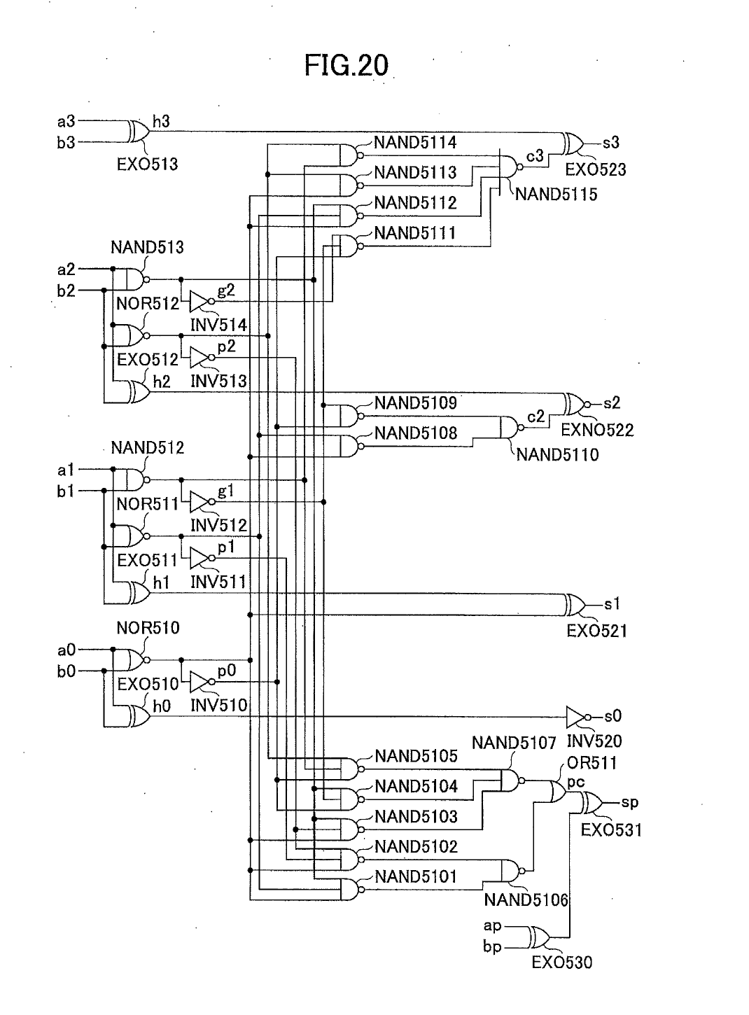

Thus, according to the first embodiment, attaching importance to improvement of the processing speed, also for the respective adders ADD6, ADD2 and ADD5 carrying out the operations of A+B+7, A+B+10 and A+B+11, configurations are provided such that the operation processing can be carried out in a time equal to the processing time taken for operation processing of 4 bit CLA processing (see FIGS. 18 and 20).

Thus, according to the configuration depicted in FIG. 9 of the first embodiment, the operation result for a case where re-complement will be carried out at a time of subtraction and no carry is generated is obtained using the adder ADD1 of A+B and the adder ADD3 of A+B+6. Then, based on the carry output signal “digit carry out” of the adder ADD1 of A+B, it is determined whether the BCD correction will be carried out. It is noted that the BCD correction here is different from the BCD correction of the above-mentioned case of “addition”. That is, in this case, as mentioned above, a configuration is provided such that the surplus 6 will not be included after the operation result has been subtracted from 15 at a time of re-complement. That is, the adder ADD2 of A+B+6 is used previously adding 6 to A+B so that “15−(r+6)” will be obtained after the operation result has been subtracted from 15.

Specifically, in a case of the carry output signal “digit carry out” COUT=0 of the adder ADD1 of A+B and not carrying out the BCD correction, the 1's complement of the output of the adder ADD1 of A+B is obtained by the inverter INV5, and thus, rs0 is obtained. In a case of carrying out BCD correction, the complement of the output of the adder ADD3 of A+B+6 is obtained by the inverter INV5, and thus, rs0 is obtained. The operation result for a case of carrying out re-complement at a time of subtraction and carry being generated from the low digit is obtained using the adder ADD4 of A+B+1 and the adder ADD6 of A+B+7. Then, based on the carry output signal “digit carry out” of the adder ADD4 of A+B+1, it is determined whether the BCD correction will be carried out. In a case of not carrying out the BCD correction (COUT=0), the 1's complement of the output of the adder ADD4 of A+B+1 is obtained by the inverter INV6, and thus, rs1 is obtained. In a case of carrying out the BCD correction (COUT=1), the 1's complement of the output of the adder ADD6 of A+B+7 is obtained by the inverter INV6, and thus, rs1 is obtained.

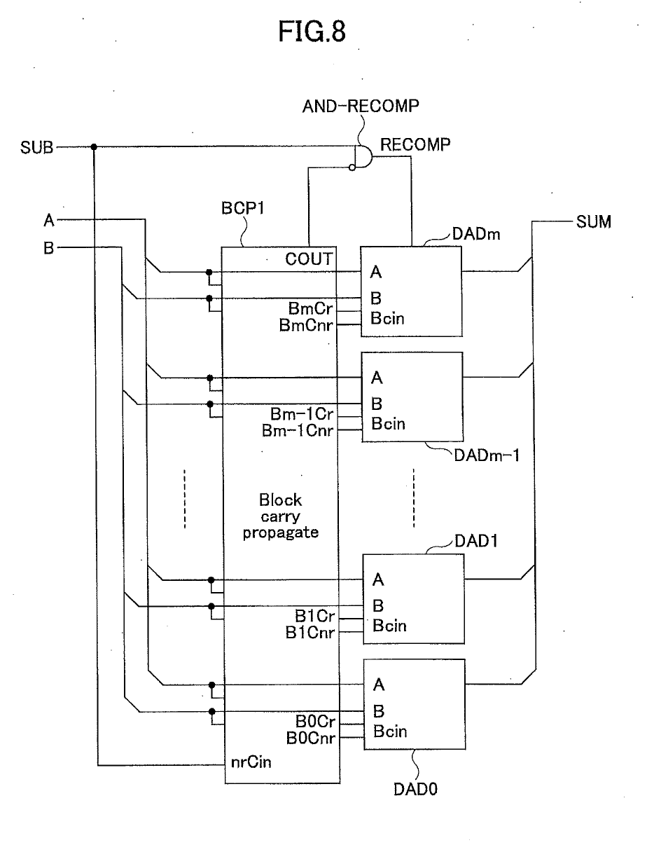

Thus, according to the first embodiment depicted in FIG. 9, the respective operations in digit units of A+B, A+B+10, A+B+6, A+B+1, A+B+11 and A+B+7 are carried out by the respective adders ADD1 to ADD6 in parallel. As a result, processing such as the BCD correction carried out by the BCD correction circuit 23, 33 or 34 of FIG. 4 or FIG. 6 becomes unnecessary. Further, it is possible to replace the process of obtaining the 9's complement carried out by the 9's complement circuit 24 of FIG. 4 or FIG. 6 by the bit inversion carried out by the inverter INV5 or INV6 obtaining the 1's complement. Further, the respective operations of A+B, A+B+10, A+B+6, A+B+1, A+B+11 and A+B+7 are carried out simultaneously in parallel together with carrying out the known carry propagation logic of a binary adder using a block carry propagation circuit BCP1 described later using FIG. 8. As a result, it is possible to realize high-speed decimal absolute value addition operation.

FIG. 8 depicts the entire configuration of the decimal absolute value adder body according to the first embodiment. In FIG. 8, each of m+1 segment absolute value adders DAD0, DAD1, . . . , DADm, for example, a segment absolute value adder DAD1 has, in the first embodiment, the configuration depicted in FIG. 9, i.e., the configuration the digit absolute value adder for each digit of a decimal number. That is, the decimal absolute value adder body according to the first embodiment is applied to a decimal absolute value adder for handling a decimal number of m+1 digits. Thus, according to the first embodiment, the above-mentioned m+1 segment absolute value adders DAD0, DAD1, . . . , DADm output a decimal absolute value addition result SUM of m+1 digits or less.

In FIG. 8, to the block carry propagation circuit BCP1, a carry propagation circuit of a binary adder can be applied, and the block carry propagation circuit BCP1 can be a high-speed carry propagation circuit applying a known carry look ahead method or the like. The block carry propagation circuit BCP1 regards the respective segment absolute value adders DAD0, DAD1, . . . , DADm as blocks, and carries out the carry propagation logic among the blocks. Further, the block carry propagation circuit BCP1 generates both carry (Bin for recomp) at a time of re-complement (hereinafter, which may be further simply referred to as “recomp” or “r”) and carry (Bin for non-recomp) at a time of not carrying out re-complement (hereinafter, which may be simply referred to as “non-recomp” or “nr”). The above-mentioned time of re-complement, i.e., in a case of carrying out re-complement, means a case where the current decimal operation is “subtraction”, and has the operation result that is negative. On the other hand, the above-mentioned time of not carrying out re-complement, i.e., in a case of not carrying out re-complement, means a case where the current decimal operation is “addition”, or “subtraction”, and has the operation result that is not negative. It is noted that in FIG. 8, for example, BmCr denotes carry at a time of re-complement for the m-th block (segment absolute value adder) DADm. BmCnr denotes carry at a time of not carrying out re-complement for the m-th block (segment absolute value adder) DADm.

The block carry propagation circuit BCP1 may have a configuration the same as a carry propagation circuit of a known binary adder. That is, in order to realize the operation “+1” (i.e., the operation of obtaining the 10's complement from the 9's complement) in the operation of obtaining the complement of the subtrahend operand at a time of “subtraction”, the signal SUB is connected to the carry input terminal nrCin for not carrying out re-complement, and the carry nrCin (the lowest Cin) for not carrying out re-complement is made to be “1” in a case of “subtraction” in which the signal SUB is “1”.

Further, in the example of FIG. 8, determination as to whether re-complement will be carried out at a time of subtraction is carried out as follows. At a time of subtraction (SUB=1), in a case where the carry output signal COUT of the block carry propagation circuit BCP1 is 0, a signal RECOMP indicating a time of re-complement is made to be “1” by an AND circuit AND-REOMP described later. The signal REOMP is inputted to the respective segment absolute value adders DAD0, DAD1, . . . , DADm, and the respective segment absolute value adders DAD0, DAD1, . . . , DADm carry out re-complement. That is, in FIG. 9, the 1's complement of any one of the outputs of the respective adders ADD1, ADD3, ADD4 and ADD6 for A+B, A+B+6, A+B+1 and A+B+7, respectively, is obtained by the inverter INV5 or INV6, and thus, the operation result is obtained.

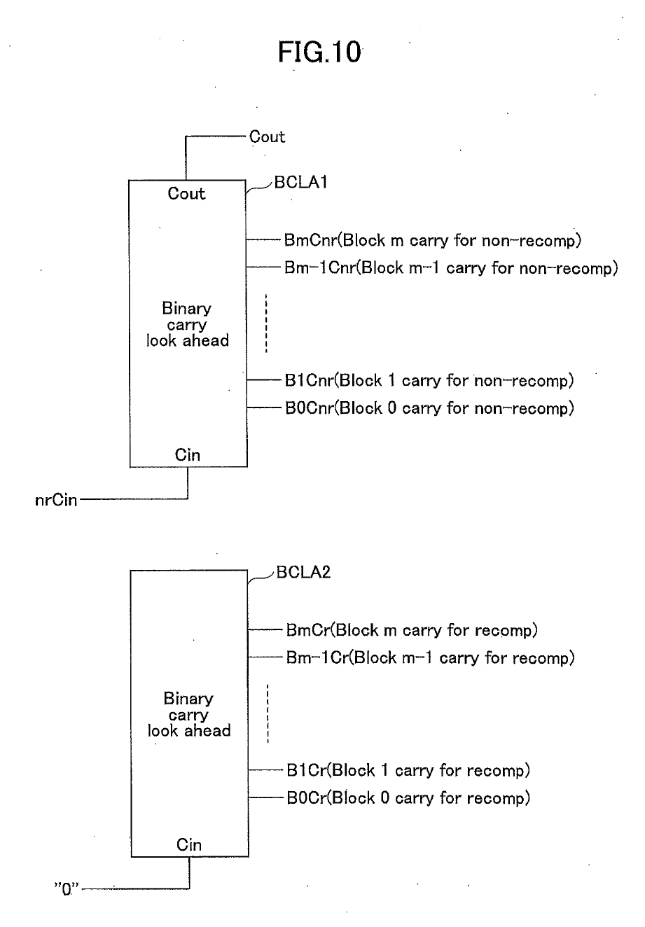

FIG. 10 is a block diagram illustrating a case where the block carry propagation circuit BCP1 depicted in FIG. 8 is formed by two binary carry look ahead circuits BCLA1 and BCLA2. As the two binary carry look ahead circuits BCLA1 and BCLA2, known binary carry look ahead circuits (i.e., carry look ahead circuits used in binary arithmetic circuits) can be applied.

The respective two binary carry look ahead circuits BCLA1 and BCLA2 generate and output carry for the respective blocks (4 bits in each block according to the first embodiment) when binary absolute value addition is carried out, based on inputted binary data A and B (not depicted in FIG. 10). The binary carry look ahead circuit BCLA1 generates carry for not carrying out re-complement. That is, the binary carry look ahead circuit BCLA1 generates B0Cnr (Block 0 carry for non-recomp), B1Cnr (Block 1 carry for non-recomp), . . . , Bm-1Cnr (Block m−1 carry for non-recomp) and BmCnr (Block m carry for non-recomp), and outputs it. On the other hand, the binary carry look ahead circuit BCLA2 generates carry for carrying out re-complement. That is, the binary carry look ahead circuit BCLA1 generates B0Cr (Block 0 carry for recomp), B1Cr (Block 1 carry for recomp), . . . , Bm-1Cr (Block m−1 carry for recomp) and BmCr (Block m carry for recomp), and outputs it.

Further, as mentioned above, in the bock carry propagation circuit BCP1 of FIG. 8, the signal SUB is connected as the carry nrCin at a time of re-complement for realizing the operation of “+1” (the operation of obtaining the 10's complement of the 9's complement) in the operation of obtaining the complement of the subtrahend operand at a time of “subtraction”. As a result, the carry nrCin is “1” in a case of “subtraction” in which the signal SUB is 1. In the case of the configuration example of FIG. 10, “0” is inputted as the (lowest) carry “Cin” of the binary carry look ahead circuit BCLA2 generating the carry for re-complement. Thus, at a time of re-complement, the (lowest) carry “Cin” of the binary carry look ahead circuit BCLA2 is made to be “0”.

On the other hand, as the carry “Cin” of the binary carry look ahead circuit BCLA1 generating the carry for not carrying out re-complement, the carry nrCin at a time of not carrying out re-complement is connected, to which the signal SUB is connected as mentioned above. As a result, at a time of “subtraction” at which the signal SUB is “1”, the (lowest) carry Cin of the carry look ahead circuit BCLA1 generating the carry at a time of not carrying out re-complement is made to be “1”. On the other hand, at a time of “addition” at which the signal SUB is “0”, the (lowest) carry Cin of the carry look ahead circuit BCLA1 is made to be “0”.

It is noted that at a time of not carrying out re-complement at a time of “subtraction”, the operation “+1” (the operation of obtaining the 10's complement of the 9's complement) is carried out in the operation of obtaining the complement of the subtrahend operand. On the other hand, in each of a time of “addition” and a time of “subtraction” with carrying out re-complement, the operation “+1” (the operation of obtaining the 10's complement of the 9's complement) is unnecessary. At a time of “addition”, in the first place, the operation of obtaining the complement of the operand is not carried out, and thus, the operation “+1” is unnecessary.

Further, at a time of re-complement at a time of “subtraction”, as mentioned above, the bit inversion is carried out by the inverter INV5 or INV6, and thus, the 9's complement is obtained. Further, in the operation of obtaining the complement in the above-mentioned preprocessing, the 9's complement is obtained by the 9's complement circuit 12 of FIG. 2, for example. Then, at a time of re-complement, the 9's complement is obtained by the bit inversion by the inverter as mentioned above. As a method of obtaining the 10's complement, there are two methods. One thereof is a method of carrying out “+1” after obtaining the 9's complement. The other thereof is a method of obtaining the 9's complement after carrying out “−1”. According to the first embodiment, the operation “+1” and the operation “−1” are canceled out in the two steps of obtaining the 10's complement, as a result of applying the former method of the above-mentioned two method to the obtaining the 10's complement in the preprocessing and applying the latter method of the two method to the obtaining the 10's complement in the carrying out re-complement on the operation result. Thus, at a time of re-complement, by thus omitting the operation “+1” and the operation “−1” from the obtaining the complement in the preprocessing and the carrying out re-complement, respectively, it is possible to thus cancel out and omit the processing of the correction value “1” obtaining the 10's complement of the 9's complement from the respective steps.

Returning to the description of FIG. 8, the decimal absolute value adder body of FIG. 8 further has the AND circuit AND-RECOMP. To the AND circuit AND-RECOMP, the signal SUB having the value “1” at a time of “subtraction” and the value “0” at a time of “addition”, and the carry output signal COUT of the block carry propagation circuit BCP1 are inputted. The AND circuit AND-RECOMP outputs the signal RECOMP having “1” at a time of re-complement and “0” at a time of not carrying out re-complement. The signal RECOMP is supplied to the respective segment absolute value adders DAD0, DAD1, . . . , DADm. The AND circuit AND-RECOMP outputs the signal RECOMP=1 at a time of subtraction (SUB=1) and also in a case where the carry output signal COUT of the block carry propagation circuit BCP1 is 0 (the subtraction result is negative). That is, re-complement will be carried out. On the other hand, in the other cases, re-complement will not be carried out. That is, at a time of “addition” (SUB=0), the signal RECOMP=0 is outputted, and thus, re-complement will not be carried out. Further, at a time of “subtraction” (SUB=1), and also, in a case where the carry output signal COUT of the block carry propagation circuit BCP1 is 1 (the subtraction result is not negative), the signal RECOMP=0 is outputted, and thus, re-complement will not be carried out.

Next, the digit absolute value adder (segment absolute value adder) depicted in FIG. 9 will be described in detail. The digit absolute value adder depicted in FIG. 9 according to the first embodiment has the above-mentioned six 4 bit adders ADD1 to ADD6 (hereinafter, which may be simply referred to as “ADD1 to ADD6”, respectively). The adder ADD1 carries out addition of A+B on input data A and B each having 4 bits expressing one digit of a decimal number. The adder ADD2 carries out addition of A+B+10 on the input data A and B. The adder ADD5 carries out addition of A+B+6 on the input data A and B. The adder ADD4 carries out addition of A+B+1 on the input data A and B. The adder ADD5 carries out addition of A+B+11 on the input data A and B. The adder ADD6 carries out addition of A+B+7 on the input data A and B. It is noted that the six adders ADD1 to ADD6 can carry out the respective addition operations in parallel.

The digit absolute value adder of FIG. 9 further has selectors SEL11 to SEL17. To the selector SEL11, the outputs of the adders ADD1 and ADD2 are inputted, respectively. The selector SEL11 selectively outputs the output of the adder ADD1 in a case where the carry output signal “digit carry out” of the adder ADD1 is 1, and outputs the output of the adder ADD2 in a case where the carry output signal “digit carry out” of the adder ADD1 is 0.

To the selector SEL12, the outputs of the adders ADD1 and ADD3 are inputted, respectively. The selector SEL12 selectively outputs the output of the adder ADD1 in a case where the carry output signal “digit carry out” of the adder ADD1 is 0, and outputs the output of the adder ADD3 in a case where the carry output signal “digit carry out” of the adder ADD1 is 1.

To the selector SEL13, the outputs of the adders ADD4 and ADD5 are inputted, respectively. The selector SEL13 selectively outputs the output of the adder ADD4 in a case where the carry output signal “digit carry out” of the adder ADD4 is 1, and outputs the output of the adder ADD5 in a case where the carry output signal “digit carry out” of the adder ADD4 is 0.

To the selector SEL14, the outputs of the adders ADD4 and ADD6 are inputted, respectively. The selector SEL14 selectively outputs the output of the adder ADD4 in a case where the carry output signal “digit carry out” of the adder ADD4 is 0, and outputs the output of the adder ADD6 in a case where the carry output signal “digit carry out” of the adder ADD4 is 1.

To the selector SEL15, the outputs of the selectors SEL11 and SEL13 are inputted, respectively. The selector SEL15 carries out the selection operation mentioned below based on the above-mentioned carry BCin for non-recomp of a time of not carrying out re-complement, i.e., the carry B0Cnr, B1Cnr, . . . , Bm-1Cnr and BmCnr. That is, in a case where the carry at a time of not carrying out re-complement is 0, the selector SEL15 selectively outputs s0 that is the output of the selector SEL11, and outputs s1 that is the output of the selector SEL13 in a case where the carry at a time of not carrying out re-complement is 1.

The inverters INV5 and INV6 invert the outputs of the selectors SEL12 and SEL14 in bit units, respectively, and output the inverted results rs0 and rs1, respectively.

To the selector SEL16, the outputs rs0 and rs1 of the inverters INV5 and INV6 are inputted, respectively.

The selector SEL16 carries out the selection operation mentioned below based on the above-mentioned carry BCin for recomp of a time of carrying out re-complement, i.e., the carry B0Cr, B1Cr, . . . , Bm-1Cr and BmCr. That is, in a case where the carry at a time of carrying out re-complement is 0, the selector SEL16 selectively outputs rs0 that is the output of the inverter INV5, and outputs rs1 that is the output of the inverter INV6 in a case where the carry at a time of carrying out re-complement is 1.

To the selector SEL17, the outputs r and rs of the selectors SEL15 and SEL16 are inputted, respectively. The selector SEL17 selectively outputs the output s of the selector SEL15 in a case where the value of the signal RECOMP depicted in FIG. 8 is 0 (i.e., at a time of not carrying out re-complement), and outputs the output rs of the selector SEL16 in a case where the value of the signal RECOMP depicted in FIG. 8 is 1 (i.e., at a time of carrying out re-complement).

It is noted that the input data A and B of the decimal absolute value adder body according to the first embodiment depicted in FIG. 8 has previously undergone the above-mentioned preprocessing. That is, by the addition circuit 13 mentioned above using FIG. 2, “+6” is carried out on the one operand op1 in each digit. That is, an offset of +6 is added. As a result, the carry propagation logic of the decimal operation is carried out by the known carry propagation logic of a binary arithmetic circuit of the above-mentioned block carry propagation circuit BCP1.

In the configuration of FIG. 9, the operation result at a time of no carry being generated from the low digit is generated using the respective adders ADD1, ADD2 and ADD3 of A+B, A+B+10 and A+B+6. It is noted that in a case of no carry being generated from the low digit, the above-mentioned respective signals of BCin for non-recomp and BCin for recomp in FIG. 9 are 0, respectively. As a result, the selectors SEL15 and SEL16 selectively output respective ones from among the operation results of the adders ADD1, ADD2 and ADD3 and the results obtained from carrying out the bit inversion on the operation results, respectively.

Because the offset of +6 has been already added to each digit as mentioned above, it is possible to determine, using the “digit carry out” signal of the adder ADD1 of A+B, whether the operation result without the above-mentioned addition of the offset +6 exceeds 9. At a time of “addition” or at a time of “subtraction” without carrying out re-complement, the operation result of the adder ADD1 of A+B corresponds to the BCD code of the operation result in a case where the operation result without the above-mentioned addition of the offset +6 exceeds 9. Further, the operation result of the adder ADD2 of A+B+10 corresponds to the BCD code of the operation result in a case where the operation result without the above-mentioned addition of the offset +6 does not exceed 9. The selector SEL11 selectively outputs the operation result of the adder ADD1 of A+B (s0) at a time of the “digit carry out” signal of the adder ADD1 of A+B being 1. On the other hand, the selector SEL11 selectively outputs the operation result of the adder ADD2 of A+B+10 (s0) at a time of the “digit carry out” signal of the adder ADD1 of A+B being 0.

On the other hand, in FIG. 9, at a time of no carry being generated from the low digit and at a time of “subtraction” with carrying out re-complement, the value obtained from inverting the operation result of the adder ADD3 of A+B+6 by the inverter INV5 corresponds to the BCD code of the operation result for a case where the operation result without the above-mentioned addition of the offset +6 exceeds 9. On the other hand, the value obtained from inverting the operation result of the adder ADD1 of A+B by the inverter INV5 corresponds to the BCD code of the operation result for a case where the operation result without the above-mentioned addition of the offset +6 does not exceed 9. The selector SEL12 selectively outputs the operation result of the adder ADD3 of A+B+6 at a time of the “digit carry out” signal of the adder ADD1 of A+B being 1, and the inverter INV5 inverts the respective bits (rs0). On the other hand, the selector SEL12 selectively outputs the operation result of the adder ADD1 of A+B at a time of the “digit carry out” signal of the adder ADD1 of A+B being 0, and the inverter INV5 inverts the respective bits (rs0). As mentioned above, the bit inversion by the inverter INV5 corresponds to the BCD correction (i.e., obtaining the 1's complement) (re-complement) as mentioned above.

On the other hand, in the configuration of FIG. 9, the operation result at a time of carry being generated from the low digit is generated using the respective adders ADD4, ADD5 and ADD6 of A+B+1, A+B+11 and A+B+7. It is noted that in a case of no carry being generated from the low digit, the above-mentioned respective signals of BCin for non-recomp and BCin for recomp of FIG. 9 are 1, respectively. As a result, the selectors SEL15 and SEL16 selectively output the respective ones from among the operation results of the adders ADD4, ADD5 and ADD6 and the results obtained from carrying out the bit inversion on the operation results, respectively.

Also in this case, because the offset of +6 has been already added to each digit as mentioned above, it is possible to determine, using the “digit carry out” signal of the adder ADD4 of A+B+1, whether the operation result without the above-mentioned addition of the offset +6 exceeds 9. At a time of “addition” or at a time of “subtraction” without carrying out re-complement, the operation result of the adder ADD4 of A+B+1 corresponds to the BCD code of the operation result in a case where the operation result without the above-mentioned addition of the offset +6 exceeds 9. Further, the operation result of the adder ADD5 of A+B+11 corresponds to the BCD code of the operation result in a case where the operation result without the above-mentioned addition of the offset +6 does not exceed 9. The selector SEL13 selectively outputs the operation result of the adder ADD4 of A+B+1 (s1) at a time of the “digit carry out” signal of the adder ADD4 of A+B+1 being 1. On the other hand, the selector SEL13 selectively outputs the operation result of the adder ADD5 of A+B+11 (s1) at a time of the “digit carry out” signal of the adder ADD4 of A+B+1 being 0.

On the other hand, in FIG. 9, at a time of no carry being generated from the low digit, and at a time of “subtraction” with carrying out re-complement, the value obtained from inverting the operation result of the adder ADD6 of A+B+7 by the inverter INV6 corresponds to the BCD code of the operation result for a case where the operation result without the above-mentioned addition of the offset +6 exceeds 9. On the other hand, the value obtained from inverting the operation result of the adder ADD4 of A+B+1 by the inverter INV6 corresponds to the BCD code of the operation result for a case where the operation result without the above-mentioned addition of the offset +6 does not exceed 9. The selector SEL14 selectively outputs the operation result of the adder ADD6 of A+B+7 at a time of the “digit carry out” signal of the adder ADD4 of A+B+1 being 1, and the inverter INV6 inverts the respective bits (rs1). On the other hand, the selector SEL14 selectively outputs the operation result of the adder ADD4 of A+B+1 at a time of the “digit carry out” signal of the adder ADD4 of A+B+1 being 0, and the inverter INV6 inverts the respective bits (rs1). As mentioned above, the bit inversion by the inverter INV6 corresponds to the BCD correction (i.e., obtaining the 1's complement) (re-complement) as mentioned above.

As mentioned above, by the carry propagation logic of a binary arithmetic circuit in the block carry propagation circuit BCP1 depicted in FIG. 8, the carry at a time of not carrying out re-complement (“BCin for non-recomp”) and the carry at a time of carrying out re-complement (“BCin for recomp”) are supplied. In the configuration of FIG. 9, based on the carry at a time of not carrying out re-complement (BCin for non-recomp), the selector SEL15 selects the above-mentioned value s0 in a case where the carry is 0, selects s1 in a case where the carry is 1, and thus, outputs s. Further, based on the carry at a time of carrying out re-complement (BCin for recomp), the selector SEL16 selects the above-mentioned value rs0 in a case where the carry is 0, selects rs1 in a case where the carry is 1, and thus, outputs rs.

Further, based on the signal RECOMP indicating whether re-complement will be carried out supplied by the AND circuit AND-RECOMP depicted in FIG. 8, the selector SEL17 of FIG. 9 selects the output s at a time of not carrying out re-complement (RECOMP=0), selects the output rs at a time of carrying out re-complement (RECOMP=1), and outputs the result “result”.

Next, respective examples of internal circuit configurations of the adders ADD1 to ADD6 depicted in FIG. 9 will be described using figures.

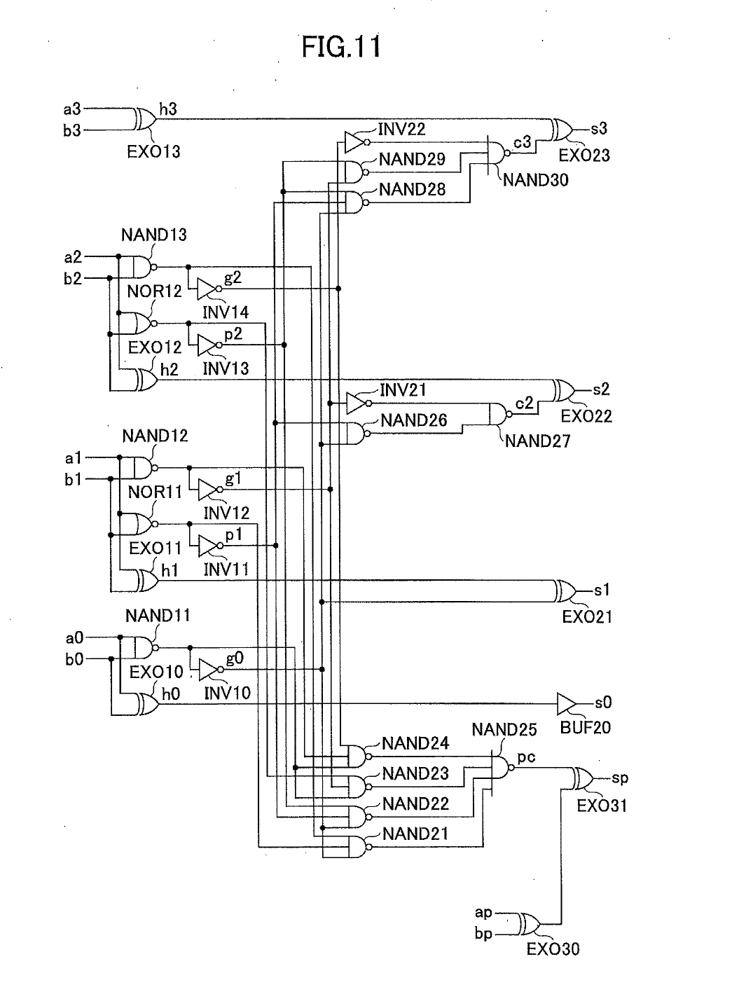

FIG. 11 is a circuit diagram illustrating one example of a circuit configuration of the adder ADD1 of A+B. In the example of FIG. 11, four bits a0, a1, a2 and a3 and four bits b0, b1, b2 and b3 of respective input data A and B, and even parity bits ap and by of the respective input data A and B are inputted. Further, the example of FIG. 11 outputs the four bits s0, s1, s2 and s3 of the operation result of A+B and the parity bit sp thereof.

The example of FIG. 11 includes a NAND circuit NAND11 to which the input bits a0 and b0 are inputted; an EXOR circuit EXO10 to which a0 and b0 are inputted and which outputs h0; and an inverter INV10 which inverts the output of the NAND11 and outputs g0. The example of FIG. 11 further includes a buffer BUF20 which buffers h0 and outputs the output bit s0.

The example of FIG. 11 further includes a NAND circuit NAND12 to which the input bits a1 and b1 are inputted; a NOR circuit NOR11 to which a1 and b1 are inputted; and an EXOR circuit EXO11 to which a1 and b1 are inputted and which outputs h1. The example of FIG. 11 further includes inverters INV11 and INV12 inverting the outputs of NAND12 and NOR11, and output p1 and g1, respectively; and an EXOR circuit EXO21 to which h1 and g0 are inputted and which outputs the output bit S1.

The example of FIG. 11 further includes a NAND circuit NAND13 to which the input bits a2 and b2 are inputted; a NOR circuit NOR12 to which a2 and b2 are inputted; and an EXOR circuit EXO12 to which a2 and b2 are inputted and which outputs h2. The example of FIG. 11 further includes inverters INV13 and INV14 inverting the outputs of NAND13 and NOR12, and output p2 and g2, respectively. The example of FIG. 11 further includes a NAND circuit NAND26 to which p1 and g0 are inputted; an inverter INV21 inverting g1; a NAND circuit NAND27 to which the respective outputs of NAND26 and the inverter INV21 are inputted and which outputs c2; and an EXOR circuit EXO22 to which h2 and c2 are inputted and which outputs the output bit s2.

The example of FIG. 11 further includes an EXOR circuit EXO13 to which the input bits a3 and b3 are inputted and which outputs h3; a NAND circuit NAND28 to which g0, p1 and p2 are inputted; a NAND circuit NAND29 to which g1 and p2 are inputted; and an inverter circuit INV22 inverting g2. The example of FIG. 11 further includes a NAND circuit NAND30 to which the respective outputs of NAND28, NAND29 and INV22 are inputted and which outputs c3; and an EXOR circuit EXO23 to which h3 and c3 are inputted and which outputs the output bit s3.

The example of FIG. 11 further includes an EXOR circuit EXO30 to which the input parity bits ap and by are inputted; and NAND circuits NAND21, NAND22, NAND23 and NAND24 to which respective values generated when the output bits s0 to s3 are generated are inputted. The example of FIG. 11 further includes a NAND circuit NAND25 to which the respective outputs of NAND21, NAND22, NAND23 and NAND24 are inputted and which outputs pc; and an EXOR circuit EXO31 to which pc and the output of EXO30 are inputted and which outputs the output parity bit sp.

In the example of FIG. 11, through the above-mentioned configuration, the respective bits s0, s1, s2 and s3 of the operation result are generated in consideration of the carry generated from the operation result of the low bits.

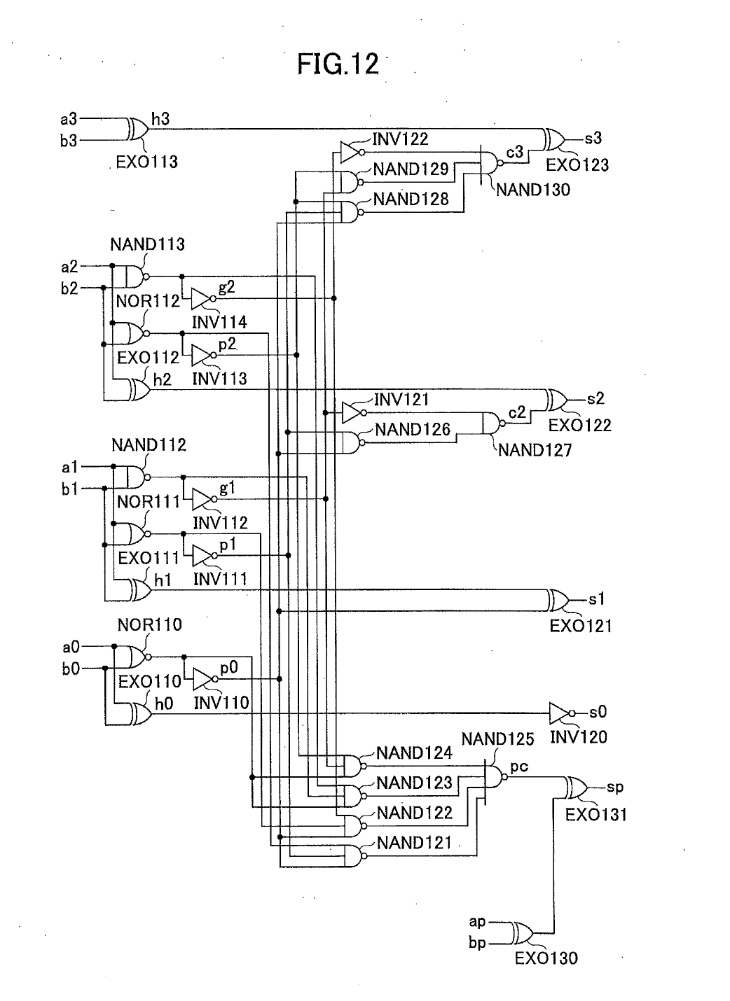

FIG. 12 is a circuit diagram illustrating one example of a circuit configuration of the adder ADD4 of A+B+1. In the example of FIG. 12, four bits a0, a1, a2 and a3 and four bits b0, b1, b2 and b3 of respective input data A and B, and even parity bits ap and by of the respective input data A and B are inputted. Further, the example of FIG. 12 outputs the four bits s0, s1, s2 and s3 of the operation result of A+B+1 and the parity bit sp thereof.

The example of FIG. 12 includes a NOR circuit NOR110 to which the input bits a0 and b0 are inputted; an EXOR circuit EXO110 to which a0 and b0 are inputted and which outputs h0; and an inverter INV110 which inverts the output of the NOR110 and outputs p0. The example of FIG. 11 further includes an inverter INV120 inverts h0 and outputs the output bit s0.

The example of FIG. 12 further includes a NAND circuit NAND112 to which the input bits a1 and b1 are inputted; a NOR circuit NOR111 to which a1 and b1 are inputted; and an EXOR circuit EXO111 to which a1 and b1 are inputted and which outputs h1. The example of FIG. 12 further includes inverters INV111 and INV112 inverting the outputs of NAND112 and NOR111, and output p1 and g1, respectively; and an EXOR circuit EXO121 to which h1 and p0 are inputted and which outputs the output bit s1.

The example of FIG. 12 further includes a NAND circuit NAND113 to which the input bits a2 and b2 are inputted; a NOR circuit NOR112 to which a2 and b2 are inputted; and an EXOR circuit EXO112 to which a2 and b2 are inputted and which outputs h2. The example of FIG. 12 further includes inverters INV113 and INV114 inverting the outputs of NAND113 and NOR112, and output p2 and g2, respectively. The example of FIG. 12 further includes a NAND circuit NAND126 to which p1 and p0 are inputted; an inverter INV121 inverting g1; a NAND circuit NAND127 to which the respective outputs of NAND126 and the inverter INV121 are inputted and which outputs c2; and an EXOR circuit EXO122 to which h2 and c2 are inputted and which outputs the output bit s2.

The example of FIG. 12 further includes an EXOR circuit EXO113 to which the input bits a3 and b3 are inputted and which outputs h3; a NAND circuit NAND128 to which p0, p1 and p2 are inputted; a NAND circuit NAND129 to which g1 and p2 are inputted; and an inverter INV122 inverting g2. The example of FIG. 12 further includes a NAND circuit NAND130 to which the respective outputs of NAND128, NAND129 and INV122 are inputted and which outputs c3; and an EXOR circuit EXO123 to which h3 and c3 are inputted and which outputs the output bit s3.

The example of FIG. 12 further includes an EXOR circuit EXO130 to which the input parity bits ap and by are inputted; and NAND circuits NAND121, NAND122, NAND123 and NAND124 to which respective values generated when the output bits s0 to s3 are generated are inputted. The example of FIG. 12 further includes a NAND circuit NAND125 to which the respective outputs of NAND121, NAND122, NAND123 and NAND124 are inputted and which outputs pc; and an EXOR circuit EXO131 to which pc and the output of EXO130 are inputted and which outputs the output parity bit sp.

In the example of FIG. 12, through the above-mentioned configuration, the respective bits s0, s1, s2 and s3 of the operation result are generated in consideration of the carry generated from the operation result of the low bits.

Next, using FIGS. 13, 14 and 15, the adder ADD3 of A+B+6 will be described. In the example of FIG. 13, four bits a0, a1, a2 and a3 and four bits b0, b1, b2 and b3 of respective input data A and B, and even parity bits ap and by of the respective input data A and B are inputted. Further, the example of FIG. 13 outputs the four bits s0, s1, s2 and s3 of an operation result of A+B+6 (actually, as will be described later, A+B−10) and the parity bit sp thereof.

The example of FIG. 13 includes a NAND circuit NAND211 to which the input bits a0 and b0 are inputted; an EXOR circuit EXO210 to which a0 and b0 are inputted and which outputs h0; and an inverter INV210 which inverts the output of the NAND211 and outputs g0. The example of FIG. 13 further includes a buffer BUF220 which buffers h0 and outputs the output bit s0.

The example of FIG. 13 further includes a NAND circuit NAND212 to which the input bits a1 and b1 are inputted; a NOR circuit NOR211 to which a1 and b1 are inputted; and an EXOR circuit EXO211 to which a1 and b1 are inputted and which outputs h1.

The example of FIG. 13 further includes inverters INV211 and INV212 inverting the outputs of NAND212 and NOR211 and outputting p1 and g1, respectively; and an EXNOR circuit EXNO221 to which h1 and g0 are inputted and which outputs the output bit s1.

The example of FIG. 13 further includes a NAND circuit NAND213 to which the input bits a2 and b2 are inputted; a NOR circuit NOR212 to which a2 and b2 are inputted; and an EXOR circuit EXO212 to which a2 and b2 are inputted and which outputs h2. The example of FIG. 13 further includes inverters INV213 and INV214 inverting the outputs of NAND213 and NOR212 and outputting p2 and g2, respectively. The example of FIG. 13 further includes an EXOR circuit EXO222 to which h2 and c2 are inputted and which outputs the output bit s2; a NAND circuit NAND250 which outputs c2; and NAND circuits NAND248 and NAND249 which input their respective outputs to NAND250.

The example of FIG. 13 further includes an EXOR circuit EXO213 to which the input bits a3 and b3 are inputted and which outputs h3; and an EXNOR circuit EXNO223 to which h3 and c3 are inputted and which outputs the output bit s3. The example of FIG. 13 further includes a NAND circuit NAND255 which outputs c3; and NAND circuits NAND251, NAND252, NAND253 and NAND254 which input their respective outputs to NAND255.

The example of FIG. 13 further includes an EXOR circuit EXO230 to which the input parity bits ap and by are inputted; and NAND circuits NAND241, NAND242, NAND243, NAND244 and NAND245 to which respective values generated when the output bits s0 to s3 are generated are inputted. The example of FIG. 13 further includes NAND circuits NAND246 and NAND247 to which the respective outputs of NAND241, NAND242, NAND243, NAND244 and NAND245 are inputted. The example of FIG. 13 further includes an OR circuit OR211 to which the respective outputs of NAND246 and NAND247 are inputted and which outputs pc; and an EXOR circuit EXO231 to which pc and the output of EXO230 are inputted and which outputs the output parity bit sp.

In the example of FIG. 13, through the above-mentioned configuration, the respective bits s0, s1, s2 and s3 of the operation result are generated in consideration of the carry and borrow generated from the operation result of the low bits.

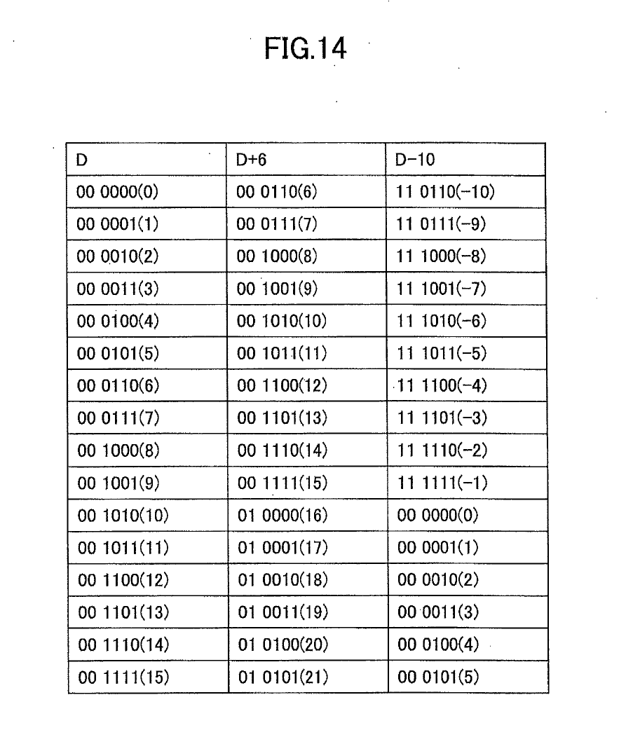

Concerning the example of FIG. 13, since a consideration for a case where carry is doubly generated would be complicated if A+B+6 were directly obtained, A+B−10 is obtained instead in the example of FIG. 13. In the example of FIG. 13, the circuit is configured in such a manner that propagation of carry and borrow will be exclusive between the carry and borrow, and thus, the single propagation path will do therefor. Since 10 is the 16's complement of 6, the bit patterns of the operation results within 4 bits are the same between A+B+6 and A+B−10. For reference, FIG. 14 depicts that the patterns of the result of the low 4 bits will be the same when respectively carrying out D+6 and D−10 for a numerical value D which can be expressed by 4 bits. In FIG. 14, 2 bits are added as high bits to the data D of 4 bits to extend it to 6 bits for binary expression for the purpose of being able to determine the sign of operation results and so forth. It is noted that in FIG. 14, the decimal expressions with the corresponding signs are provided in parentheses. From FIG. 14, it is clear that the binary bit patterns of low 4 bits are the same between D+6 and D−10.

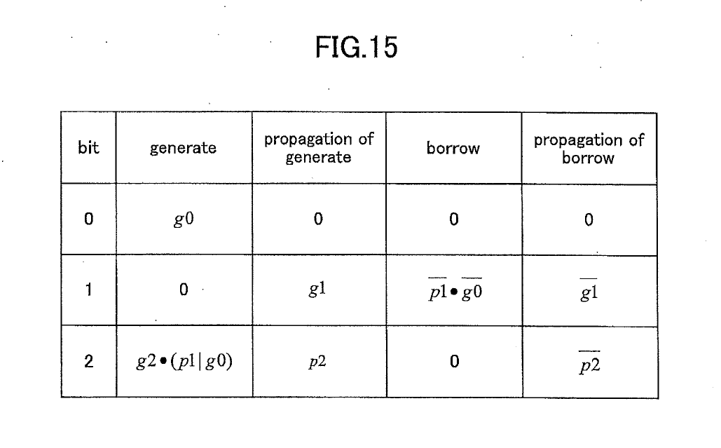

In order to obtain the outputs bits s3 to s0 of the operation result, the carry and borrow generated from the input bits a2 to a0 and b2 to b0 are used. FIG. 15 depicts the contents of the carry and borrow generated from the respective bits. In FIG. 15, “bit” depicts the bit numbers (the respective numeral parts of “a2” to “a0” and “b2” to “b0”); “generate” depicts the carry generated by the bits themselves; “propagation of generate” depicts the propagation of carry generated by the low bits; “borrow” depicts the borrow generated by the bits themselves; “propagation of borrow” depicts the propagation of borrow generated by the low bits.

Below, the logical expressions of the operation result s0, s1, s2 and s3; the even parity sp of the operation result; the conditions c0, c1, c2 and c3 for inversions of the data due to the carry or borrow; and the conditions pc for inversion of the parity will be depicted together (Formula 4). It is noted that in the logical expression of Formula 4, the operator of Formula 1 depicted below denotes the operator executing logical EXOR operation:

⊕ [Formula 1]

The operator of Formula 2 depicted below denotes the operator executing logical AND operation:

 [Formula 2]

The operator of Formula 3 depicted below denotes the operator executing logical OR operation:

$$\begin{matrix}\vert & [ Formula 3 ] \\ hi = ai ⊕ bi \\ gi = ai \cdot bi \\ pi = ai \vert bi \\ s 0 = h 0 ⊕ 0 ⊕ c 0 \\ s 1 = h 1 ⊕ 1 ⊕ c 1 \\ s 2 = h 2 ⊕ 0 ⊕ c 2 \\ s 3 = h 3 ⊕ 1 ⊕ c 3 \\ sp = ( ap ⊕ bp ) ⊕ pc \\ c 0 = 0 \\ c 1 = g 0 \vert 0 \\ c 2 = ( g 1 \cdot g 0 ) \vert ( \overline{p 1} \cdot \overline{g 0} ) \\ c 3 = ( g 2 \cdot p 1 \vert g 2 \cdot g 0 \vert p 2 \cdot g 1 \cdot p 0 ) \vert ( \overline{p 2} \cdot \overline{p 1} \cdot \overline{g 0} ) \\ \begin{matrix}pc = c 0 ⊕ c 1 ⊕ c 2 ⊕ c 3 \\ = g 2 \cdot p 1 \cdot \overline{g 0} \vert p 2 \cdot \overline{p 1} \cdot \overline{g 0} \vert g 2 \cdot p 2 \cdot g 0 \vert \overline{g 2} \cdot \\ \overline{g 1} \cdot g 0 \vert p 2 \cdot g 1 \cdot g 0\end{matrix} & [ Formula 4 ]\end{matrix}$$

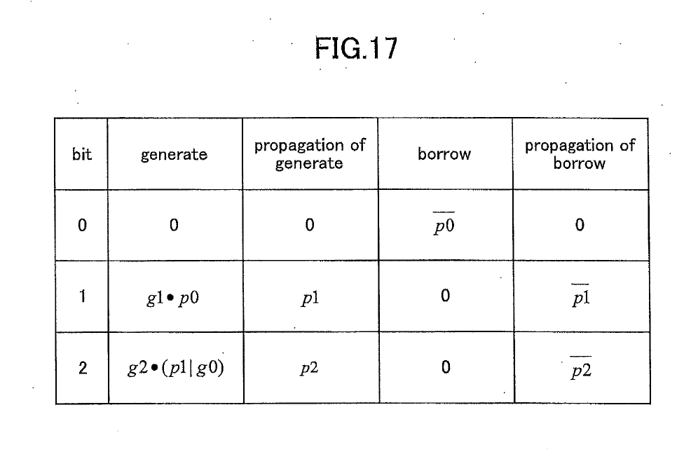

Next, using FIGS. 16 and 17, the adder ADD6 of A+B+7 will be described. In the example of FIG. 16, four bits a0, a1, a2 and a3 and four bits b0, b1, b2 and b3 of respective input data A and B, and even parity bits ap and by of the respective input data A and B are inputted. Further, the example of FIG. 16 outputs the four bits s0, s1, s2 and s3 of the operation result of A+B+7 (actually, as will be described later, A+B−9) and the parity bit sp thereof.

The example of FIG. 16 includes a NOR circuit NOR310 to which the input bits a0 and b0 are inputted; an EXOR circuit EXO310 to which a0 and b0 are inputted and which outputs h0; and an inverter INV310 which inverts the output of the NOR310 and outputs p0. The example of FIG. 16 further includes an inverter INV320 inverting h0 and outputting the output bit s0.

The example of FIG. 16 further includes a NAND circuit NAND312 to which the input bits a1 and b1 are inputted; a NOR circuit NOR311 to which a1 and b1 are inputted; and an EXOR circuit EXO311 to which a1 and b1 are inputted and which outputs h1. The example of FIG. 16 further includes inverters INV311 and INV312 inverting the outputs of NAND312 and NOR311, and outputting p1 and g1, respectively; and an EXOR circuit EXO321 outputting the output bit s1.

The example of FIG. 16 further includes a NAND circuit NAND313 to which the input bits a2 and b2 are inputted; a NOR circuit NOR312 to which a2 and b2 are inputted; and an EXOR circuit EXO312 to which a2 and b2 are inputted and which outputs h2. The example of FIG. 16 further includes inverters INV313 and INV314 inverting the outputs of NAND313 and NOR312, and outputting p2 and g2, respectively. The example of FIG. 16 further includes an EXOR circuit EXO322 to which h2 and c2 are inputted and which outputs the output bit s2; a NAND circuit NAND368 which outputs c2; and NAND circuits NAND366 and NAND367 which input their respective outputs to NAND368.

The example of FIG. 16 further includes an EXOR circuit EXO313 to which the input bits a3 and b3 are inputted and which outputs h3; and an EXNOR circuit EXNO323 to which h3 and c3 are inputted and which outputs the output bit s3. The example of FIG. 16 further includes a NAND circuit NAND373 which outputs c3; and NAND circuits NAND369, NAND370, NAND371 and NAND372 which input their respective outputs to NAND373.

The example of FIG. 16 further includes an EXOR circuit EXO330 to which the input parity bits ap and by are inputted; and NAND circuits NAND361, NAND362, NAND363 and NAND364 to which respective values generated when the output bits s0 to s3 are generated are inputted. The example of FIG. 16 further includes a NAND circuit NAND365 to which the respective outputs of NAND361, NAND362, NAND363 and NAND364 are inputted. The example of FIG. 16 further includes an EXOR circuit EXO331 to which the output pc of NAND365 and the output of EXO330 are inputted and which outputs the output parity bit sp.

In the example of FIG. 16, through the above-mentioned configuration, the respective bits s0, s1, s2 and s3 of the operation result are generated in consideration of the carry and borrow generated from the operation result of the low bits.

Concerning the example of FIG. 16, since a consideration for a case where carry is doubly generated would be complicated if A+B+7 were directly obtained, A+B−9 is obtained instead in the example of FIG. 16. In the example of FIG. 16, the circuit is configured in such a manner that the propagation of carry and borrow will be exclusive between the carry and borrow, and thus, the single propagation path will do therefor. Since 9 is the 16's complement of 7, the bit patterns of the operation results within 4 bits are the same between A+B+7 and A+B−9. FIG. 17 depicts the contents of the carry and borrow generated from the respective bits.

Below, the logical expressions of the operation result s0, s1, s2 and s3; the even parity sp of the operation result; the conditions c0, c1, c2 and c3 for inversions of the data due to the carry or borrow; and the conditions pc for inversion of the parity will be depicted together (Formula 5).

$$hi = ai ⊕ bi \\ gi = ai \cdot bi \\ pi = ai \vert bi \\ s 0 = h 0 ⊕ 1 ⊕ c 0 \\ s 1 = h 1 ⊕ 0 ⊕ c 1 \\ s 2 = h 2 ⊕ 0 ⊕ c 2 \\ s 3 = h 3 ⊕ 1 ⊕ c 3 \\ sp = ( ap ⊕ bp ) ⊕ pc \\ c 0 = 0 \\ c 1 = 0 \vert \overline{p 0} \\ c 2 = ( g 1 \cdot p 0 ) \vert ( \overline{p 1} \cdot \overline{p 0} ) \\ c 3 = ( g 2 \cdot p 1 \vert g 2 \cdot p 0 \vert p 2 \cdot g 1 \cdot p 0 ) \vert ( \overline{p 2} \cdot \overline{p 1} \cdot \overline{p 0} ) \\ \begin{matrix}pc = c 0 ⊕ c 1 ⊕ c 2 ⊕ c 3 \\ = g 2 \cdot \overline{g 1} \cdot p 0 \vert \overline{p 2} \cdot g 1 \vert \overline{p 2} \cdot \overline{p 0} \vert \overline{g 2} \cdot p 1 \cdot \overline{p 0}\end{matrix} \qquad [ Formula 5 ]$$

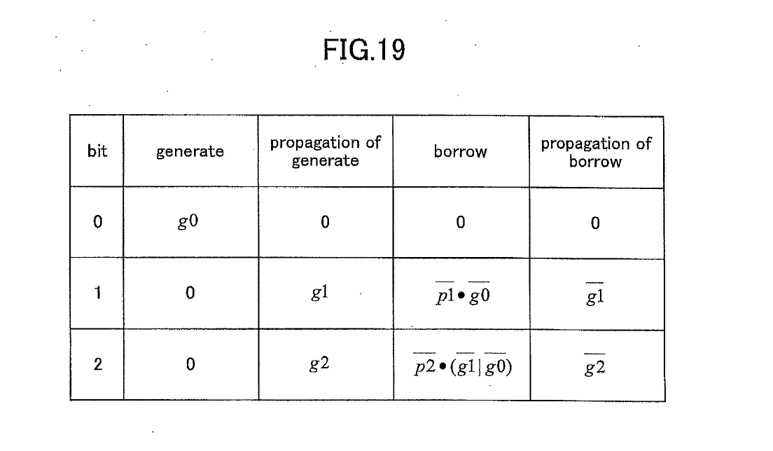

Next, using FIGS. 18 and 19, the adder ADD2 of A+B+10 will be described. In the example of FIG. 18, four bits a0, a1, a2 and a3 and four bits b0, b1, b2 and b3 of respective input data A and B, and even parity bits ap and by of the respective input data A and B are inputted. Further, the example of FIG. 18 outputs the four bits s0, s1, s2 and s3 of the operation result of A+B+10 (actually, as will be described later, A+B−6) and the parity bit sp thereof.

The example of FIG. 18 includes a NAND circuit NAND411 to which the input bits a0 and b0 are inputted; an EXOR circuit EXO410 to which a0 and b0 are inputted and which outputs h0; and an inverter INV410 which inverts the output of the NAND411 and outputs g0. The example of FIG. 18 further includes a buffer BUF420 buffering h0 and outputting the output bit s0.

The example of FIG. 18 further includes a NAND circuit NAND412 to which the input bits a1 and b1 are inputted; a NOR circuit NOR411 to which a1 and b1 are inputted; and an EXOR circuit EXO411 to which a1 and b1 are inputted and which outputs h1.

The example of FIG. 18 further includes inverters INV411 and INV412 inverting the outputs of NAND412 and NOR411, and outputting p1 and g1, respectively; and an EXNOR circuit EXNO421 outputting the output bit s1.

The example of FIG. 18 further includes a NAND circuit NAND413 to which the input bits a2 and b2 are inputted; a NOR circuit NOR412 to which a2 and b2 are inputted; and an EXOR circuit EXO412 to which a2 and b2 are inputted and which outputs h2. The example of FIG. 18 further includes inverters INV413 and INV414 inverting the outputs of NAND413 and NOR412, and outputting p2 and g2, respectively. The example of FIG. 18 further includes an EXNOR circuit EXN0422 to which h2 and c2 are inputted and which outputs the output bit s2; a NAND circuit NAND488 which outputs c2; and NAND circuits NAND486 and NAND487 which input their respective outputs to NAND488.

The example of FIG. 18 further includes an EXOR circuit EXO413 to which the input bits a3 and b3 are inputted and which outputs h3; and an EXOR circuit EXO423 to which h3 and c3 are inputted and which outputs the output bit s3. The example of FIG. 18 further includes a NAND circuit NAND493 which outputs c3; and NAND circuits NAND489, NAND490, NAND491 and NAND492 which input their respective outputs to NAND493.

The example of FIG. 18 further includes an EXOR circuit EXO430 to which the input parity bits ap and by are inputted; and NAND circuits NAND481, NAND482, NAND483 and NAND484 to which respective values generated when the output bits s0 to s3 are generated are inputted. The example of FIG. 18 further includes a NAND circuit NAND485 to which the respective outputs of NAND481, NAND482, NAND483 and NAND484 are inputted. The example of FIG. 18 further includes an EXOR circuit EXO431 to which the output pc of NAND485 and the output of EXO430 are inputted and which outputs the output parity bit sp.

In the example of FIG. 18, through the above-mentioned configuration, the respective bits s0, s1, s2 and s3 of the operation result are generated in consideration of the carry and borrow generated from the operation result of the low bits.

Concerning the example of FIG. 18, since a consideration for a case where carry is doubly generated would be complicated if A+B+10 were directly obtained, A+B−6 is obtained instead in the example of FIG. 18. In the example of FIG. 18, the circuit is configured in such a manner that the propagation of carry and borrow will be exclusive between the carry and borrow, and thus, the single propagation path will do therefor. Since 6 is the 16's complement of 10, the bit patterns of the operation results within 4 bits are the same between A+B+10 and A+B−6. FIG. 19 depicts the contents of the carry and borrow generated from the respective bits.

Below, the logical expressions of the operation result s0, s1, s2 and s3; the even parity sp of the operation result; the conditions c0, c1, c2 and c3 for inversions of the data due to the carry or borrow; and the conditions pc for inversion of the parity will be depicted together (Formula 6).

$$hi = ai ⊕ bi \\ gi = ai \cdot bi \\ pi = ai \vert bi \\ s 0 = h 0 ⊕ 0 ⊕ c 0 \\ s 1 = h 1 ⊕ 1 ⊕ c 1 \\ s 2 = h 2 ⊕ 1 ⊕ c 2 \\ s 3 = h 3 ⊕ 0 ⊕ c 3 \\ sp = ( ap ⊕ bp ) ⊕ pc \\ c 0 = 0 \\ c 1 = g 0 \vert 0 \\ c 2 = ( g 1 \cdot g 0 ) \vert ( \overline{p 1} \cdot \overline{g 0} ) \\ c 3 = ( g 2 \cdot g 1 \cdot g 0 ) \vert ( \overline{p 2} \cdot \overline{g 1} \vert \overline{p 2} \cdot \overline{g 0} \vert \overline{g 2} \cdot \overline{p 1} \cdot \overline{g 0} ) \\ \begin{matrix}pc = c 0 ⊕ c 1 ⊕ c 2 ⊕ c 3 \\ = \overline{p 2} \cdot p 1 \cdot \overline{g 0} \vert g 2 \cdot \overline{p 1} \vert g 2 \cdot g 0 \vert p 2 \cdot \overline{g 1} \cdot g 0\end{matrix} \qquad [ Formula 6 ]$$

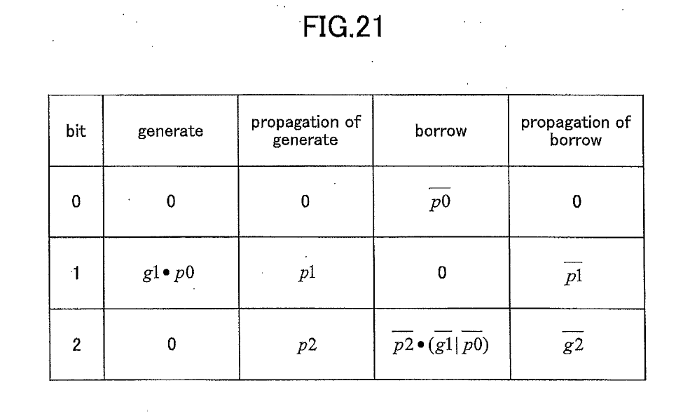

Next, using FIGS. 20 and 21, the adder ADD5 of A+B+11 will be described. In the example of FIG. 20, four bits a0, a1, a2 and a3 and four bits b0, b1, b2 and b3 of respective input data A and B, and even parity bits ap and by of the respective input data A and B are inputted. Further, the example of FIG. 20 outputs the four bits s0, s1, s2 and s3 of the operation result of A+B+11 (actually, as will be described later, A+B−5) and the parity bit sp thereof.

The example of FIG. 20 includes a NOR circuit NOR510 to which the input bits a0 and b0 are inputted; an EXOR circuit EXO510 to which a0 and b0 are inputted and which outputs h0; and an inverter INV510 which inverts the output of the NOR510 and outputs p0. The example of FIG. 20 further includes an inverter INV520 inverting h0 and outputting the output bit s1.

The example of FIG. 20 further includes a NAND circuit NAND512 to which the input bits a1 and b1 are inputted; a NOR circuit NOR511 to which a1 and b1 are inputted; and an EXOR circuit EXO511 to which a1 and b1 are inputted and which outputs h1. The example of FIG. 20 further includes inverters INV511 and INV512 inverting the outputs of NAND512 and NOR511, and outputting p1 and g1, respectively; and an EXOR circuit EXO521 outputting the output bit s1.

The example of FIG. 20 further includes a NAND circuit NAND513 to which the input bits a2 and b2 are inputted; a NOR circuit NOR512 to which a2 and b2 are inputted; and an EXOR circuit EXO512 to which a2 and b2 are inputted and which outputs h2. The example of FIG. 20 further includes inverters INV513 and INV514 inverting the outputs of NAND513 and NOR512, and outputting p2 and g2, respectively. The example of FIG. 20 further includes an EXNOR circuit EXNO522 to which h2 and c2 are inputted and which outputs the output bit s2; a NAND circuit NAND5110 which outputs c2; and NAND circuits NAND5108 and NAND5109 which input their respective outputs to NAND5110.

The example of FIG. 20 further includes an EXOR circuit EXO513 to which the input bits a3 and b3 are inputted and which outputs h3; and an EXOR circuit EXO523 to which h3 and c3 are inputted and which outputs the output bit s3. The example of FIG. 20 further includes a NAND circuit NAND5115 which outputs c3; and NAND circuits NAND5111, NAND5112, NAND5113 and NAND5114 which input their respective outputs to NAND5115.

The example of FIG. 20 further includes an EXOR circuit EXO530 to which the input parity bits ap and by are inputted; and NAND circuits NAND5101, NAND5102, NAND5103, NAND5104 and NAND5105 to which respective values generated when the output bits s0 to s3 are generated are inputted. The example of FIG. 20 further includes NAND circuits NAND5106 and NAND5107 to which the respective outputs of the NAND5101, NAND5102, NAND5103, NAND5104 and NAND5105 are inputted. The example of FIG. 20 further includes an OR circuit OR511 outputting pc; and an EXOR circuit EXO531 to which pc and the output of EXO530 are inputted and which outputs the output parity bit sp.

In the example of FIG. 20, through the above-mentioned configuration, the respective bits s0, s1, s2 and s3 of the operation result are generated in consideration of the carry and borrow generated from the operation result of the low bits.

Concerning the example of FIG. 20, since a consideration for a case where carry is doubly generated would be complicated if A+B+11 were directly obtained, A+B−5 is obtained instead in the example of FIG. 20. In the example of FIG. 20, the circuit is configured in such a manner that the propagation of carry and borrow will be exclusive between the carry and borrow, and thus, the single propagation path will do therefor. Since 5 is the 16's complement of 11, the bit patterns of the operation results within 4 bits are the same between A+B+11 and A+B−5. FIG. 21 depicts the contents of the carry and borrow generated from the respective bits.

Below, the logical expressions of the operation result s0, s1, s2 and s3; the even parity sp of the operation result; the conditions c0, c1, c2 and c3 for inversions of the data due to the carry or borrow; and the conditions pc for inversion of the parity will be depicted together (Formula 7).

$$hi = ai ⊕ bi \\ gi = ai \cdot bi \\ pi = ai \vert bi \\ s 0 = h 0 ⊕ 1 ⊕ c 0 \\ s 1 = h 1 ⊕ 0 ⊕ c 1 \\ s 2 = h 2 ⊕ 1 ⊕ c 2 \\ s 3 = h 3 ⊕ 0 ⊕ c 3 \\ sp = ( ap ⊕ bp ) ⊕ pc \\ c 0 = 0 \\ c 1 = 0 \vert \overline{p 0} \\ c 2 = ( g 1 \cdot p 0 ) \vert ( \overline{p 1} \cdot \overline{p 0} ) \\ c 3 = ( g 2 \cdot p 1 \cdot p 0 ) \vert ( \overline{p 2} \cdot \overline{g 1} \vert \overline{g 2} \cdot \overline{p 1} \cdot \overline{p 0} \vert \overline{p 2} \cdot \overline{p 0} ) \\ \begin{matrix}pc = c 0 ⊕ c 1 ⊕ c 2 ⊕ c 3 \\ = \overline{p 2} \cdot \overline{g 1} \cdot p 0 \vert \overline{g 2} \cdot g 1 \cdot p 0 \vert \overline{g 2} \cdot p 2 \cdot \overline{p 0} \vert p 2 \cdot \\ p 1 \cdot \overline{p 0} \vert \overline{g 2} \cdot \overline{p 1} \cdot \overline{p 0}\end{matrix} \qquad [ Formula 7 ]$$

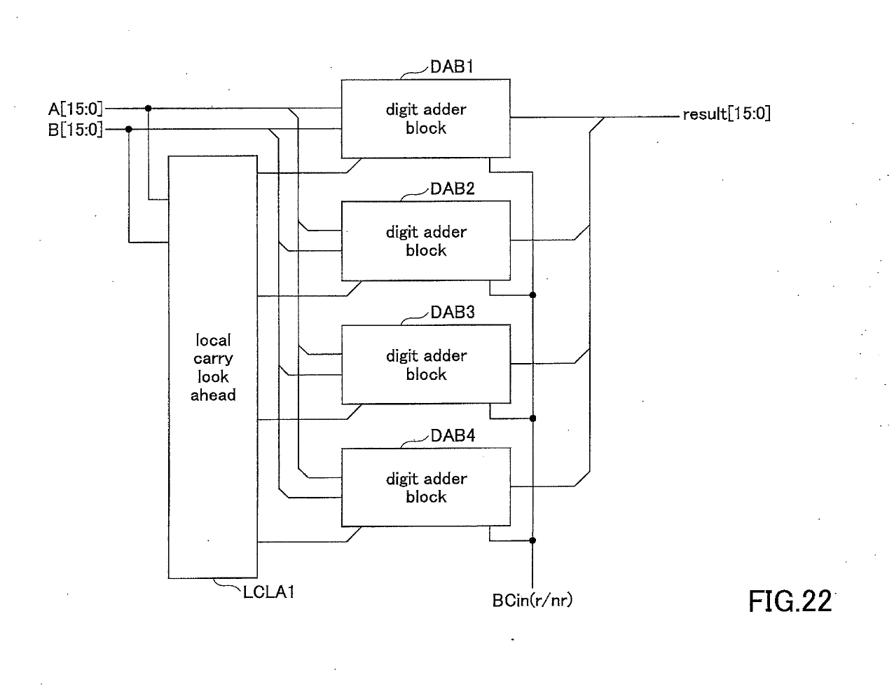

Below, the second embodiment will be described. According to the second embodiment, each of the segment absolute value adders DAD0, DAD1, . . . , DADm depicted in FIG. 8 in the above-described first embodiment is, not in single-digit units, but in plural-digit units. That is, according to the second embodiment, each of the segment absolute value adders DAD0, DAD1, . . . , DADm, for example, the segment absolute value adder DAD1 includes, as depicted in FIG. 22, plural (in the example of FIG. 22, four) digit adder blocks DAB1 to DAB4.

Thus, the segment absolute value adder depicted in FIG. 22 includes the configuration for four digits, and thus, has a configuration of 16 bits (4×4 =16) ([15:0]). Further, the segment absolute value adder depicted in FIG. 22 includes a local carry look ahead circuit (“local carry look ahead”) LCLA1. The local carry look ahead circuit LCLA1 carries out the carry propagation logic within the four-digit unit, i.e., among the four digit adder blocks DAB1 to DAB4. Thus, according to the second embodiment, the block carry propagation circuit BCP1 depicted in FIG. 8 generates carry for 4-digit units, and supplies the carry to the respective segment absolute value adders DAD0, DAD1, . . . , DADm. Thus, according to the second embodiment, the carry propagation logic is hierarchized into the inside (local carry look ahead circuit LCLA1) of each of the segment absolute value adders DAD0, DAD1, . . . , DADm of 4-digit units and the outside (block carry propagation circuit BCP1) of the respective segment absolute value adders DAD0, DAD1, . . . , DADm of 4-digit units. As a result, it is possible to carry out the local carry propagation in parallel (parallel processing) in the inside (local carry look ahead circuit LCLA1) of each of the segment absolute value adders DAD0, DAD1, . . . , DADm of 4-digit units and the outside (block carry propagation circuit BCP1) of the respective segment absolute value adders DAD0, DAD1, . . . , DADm of 4-digit units.

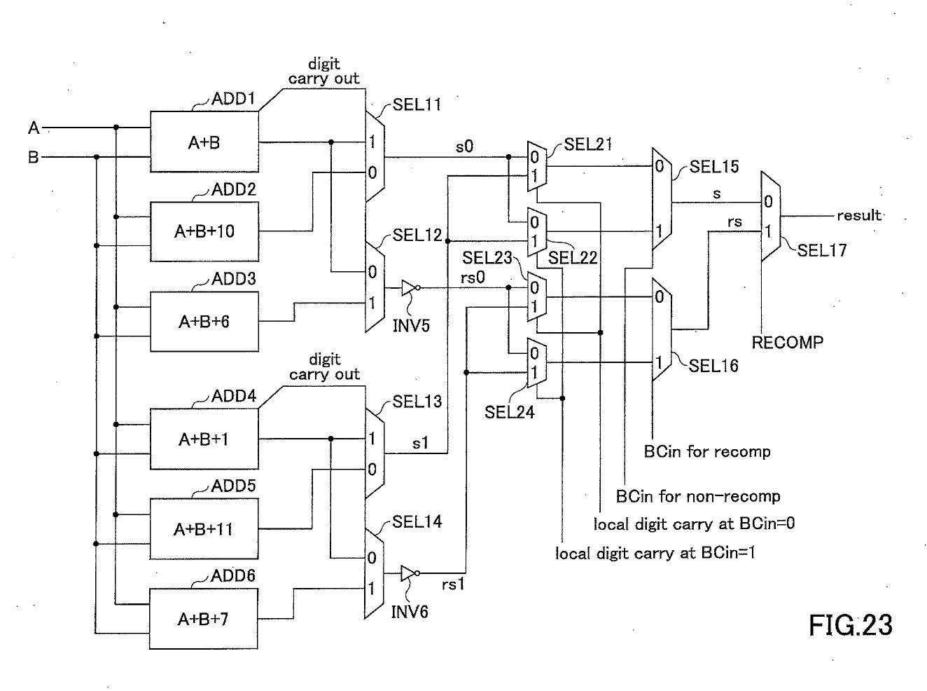

FIG. 23 depicts one example of a configuration of each of the digit adder blocks DAB1 to DAB4 depicted in FIG. 22, for example, the digit adder block DAD3. The digit adder block according to the second embodiment depicted in FIG. 23 has a configuration similar to the configuration of the segment absolute value adder of digit unit depicted in FIG. 9, the same reference numerals/letters are given to the corresponding elements, and duplicate description will be omitted. The digit adder block depicted in FIG. 23 is different from the segment absolute value adder depicted in FIG. 9 in that selectors SEL21, SEL22, SEL23 and SEL24 are included in the digit adder block depicted in FIG. 23.

In a case of employing the configuration of FIG. 23, the local carry look ahead circuit LCLA1 depicted in FIG. 22 carries out the following operations. That is, the local carry look ahead circuit LCLA1 carries out the following operations so as to respond to whether input data A and B of 4-digit unit and carry BCin (“BCin for recomp” or “BCin for non-recomp”) of 4-digit unit are “0” or “1”. According the known carry propagation logic (used in a binary arithmetic circuit) of the local look ahead circuit LCLA1, the local look ahead circuit LCLA1 generates carry for digit units. More specifically, the local look ahead circuit LCLA1 generates carry “local digit carry at BCin=0” of digit unit to correspond to a case where the carry BCin of 4-digit unit is “0” supplied by the block carry propagation circuit BCP1. Further, the local look ahead circuit LCLA1 generates carry “local digit carry at BCin=1” of digit unit to correspond to a case where the carry BCin of 4-digit unit is “1” supplied by the block carry propagation circuit BCP1. Then, the local carry look ahead circuit LCLA1 depicted in FIG. 22 supplies the thus generated carry “local digit carry at BCin=0” and carry “local digit carry at BCin=1” to the digit adder blocks DAB1 to DAB4, respectively. That is, the local carry look ahead circuit LCLA1 depicted in FIG. 22 supplies the carry “local digit carry at BCin=0” and the carry “local digit carry at BCin=1” to the digit adder block depicted in FIG. 23.

In FIG. 23, the supplied carry “local digit carry at BCin=0” is inputted to the selectors SEL21 and SEL23. In a case where the carry “local digit carry at BCin=0” is “0”, the selector SEL21 selectively outputs the output s0 of the selector SEL11 to the selector SEL15. In a case where the carry “local digit carry at BCin=0” is “1”, the selector SEL21 selectively outputs the output s1 of the selector SEL13 to the selector SEL15. In a case where the carry “local digit carry at BCin=0” is “0”, the selector SEL23 selectively outputs the output rs0 of the inverter INV5 to the selector SEL16. In a case where the carry “local digit carry at BCin=0” is “1”, the selector SEL23 selectively outputs the output rs1 of the inverter INV6 to the selector SEL16.

On the other hand, the supplied carry “local digit carry at BCin=1” is inputted to the selectors SEL22 and SEL24. In a case where the carry “local digit carry at BCin=1” is “0”, the selector SEL22 selectively outputs the output s0 of the selector SEL11 to the selector SEL15. In a case where the carry “local digit carry at BCin=1” is “1”, the selector SEL22 selectively outputs the output s1 of the selector SEL13 to the selector SEL15. In a case where the carry “local digit carry at BCin=1” is “0”, the selector SEL24 selectively outputs the output rs0 of the inverter INV5 to the selector SEL16. In a case where the carry “local digit carry at BCin=1” is “1”, the selector SEL24 selectively outputs the output rs1 of the inverter INV6 to the selector SEL16.

Each of the selectors SEL15 and SEL16 carries out the selecting and outputting operation according to the above-mentioned signal “BCin for non-recomp” or “BCin for recomp” of 4-digit unit supplied by the block carry propagation circuit BCP1, in the same way as the case of FIG. 9 described above. Also, the selector SEL17 carries out the selecting and outputting operation according to the signal “RECOMP” depicted in FIG. 8, in the same way as the case of FIG. 9 described above.

The other operations in the digit adder block of FIG. 23 are the same as or similar to those of the segment absolute value adder of digit unit depicted in FIG. 9.

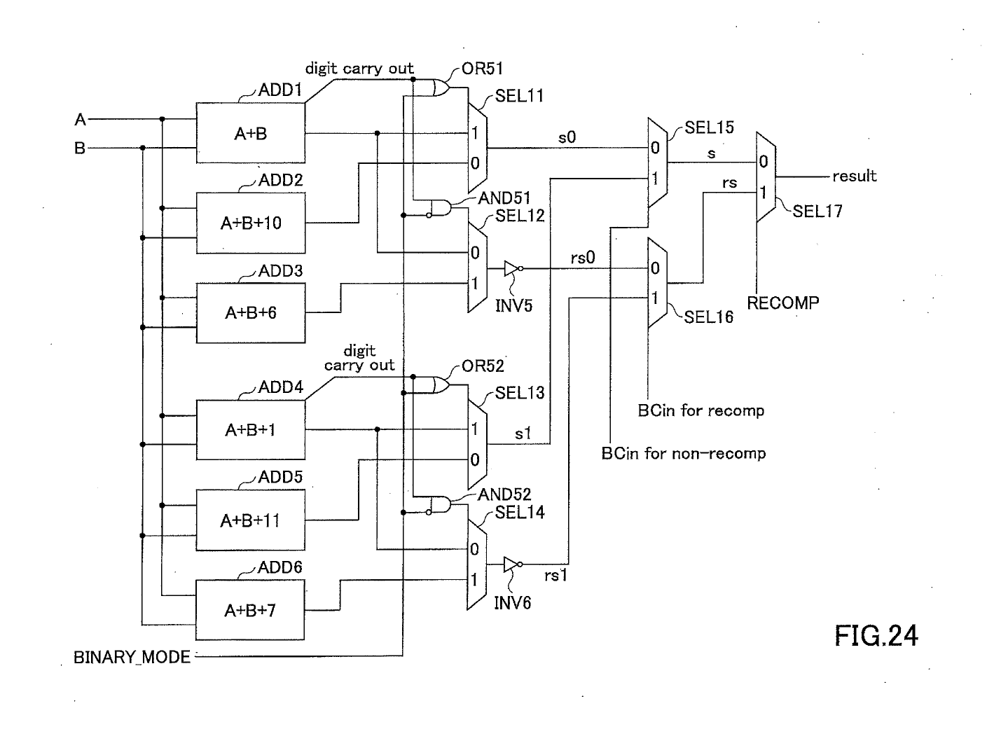

Next, the third embodiment will be described. According to the third embodiment, a small number of gates are added to the segment absolute value adder of digit unit depicted in FIG. 9 of the first embodiment so that the segment absolute value adder can also operate as a binary absolute value adder. FIG. 24 depicts one example of a configuration of the segment absolute value adder of digit unit according to the third embodiment. In comparison to the configuration of FIG. 9, gates are added, for carrying out logical operations with a “BINARY_MODE” signal, to the parts by which the “digit carry out” signal is used to control the operations of the selectors SEL11, SEL12, SEL13 and SEL14. The gates that are thus added are an OR circuit OR51, an AND circuit AND51, an OR circuit OR52 and an AND circuit AND52. To the OR circuit OR51, AND circuit AND51, OR circuit OR52 and AND circuit AND52, the “digit carry out” signals and the “BINARY_MODE” signal are inputted, respectively. The “BINARY_MODE” signal is a signal being “0” for selecting decimal operation and being “1” for selecting binary operation.

When the “BINARY_MODE” signal is “0”, the OR circuit OR51 causes the “digitally carry out” signal from the adder ADD1 to pass therethrough, as it is, to the selector SEL11 outputting s0. As a result, the same configuration as that of FIG. 9 is obtained here, and thus, concerning s0, decimal operation equal to that of the case of FIG. 9 is obtained. On the other hand, when the “BINARY_MODE” signal is “1”, OR51 continuously outputs “1”, and the selector SEL11 continuously selects the operation result of the adder ADD1.

Further, AND51 controlling the operation of the selector SEL12 outputting rs0 via the inverter INV5 carries out logical AND of the value obtained from inverting the “BINARY_MODE” signal and the “digital carry out” signal from the adder ADD1. Thus, when the “BINARY_MODE” signal is “0”, the selector SEL12 is controlled by the “digital carry out” signal. Thus, concerning rs0, decimal operation equal to that of the case of FIG. 9 is obtained. On the other hand, when the “BINARY_MODE” signal is “1”, the AND51 continuously outputs “0”, and thus, the selector SEL12 continuously selects the output of the adder ADD1.

The respective selectors SEL13 outputting s1 and SEL14 outputting rs1 via the inverter INV6 are controlled in the same way as the cases of s0 and rs0 described above. Thus, in the case where the “BINARY_MODE” signal is “0”, the circuit of FIG. 24 carries out decimal operation equal to that of the circuit of FIG. 9. On the other hand, in the case where the “BINARY_MODE” signal is “1”, s0 is continuously the operation result (A+B) of the adder ADD1, and rs0 is continuously the 2's complement of the operation result (A+B) of the adder ADD1. Further, in the case where the “BINARY_MODE” signal is “1”, s1 is continuously the operation result (A+B+1) of the adder ADD4, and rs1 is continuously the 2's complement of the operation result (A+B+1) of the adder ADD4.

Thus, in the case where the “BINARY_MODE” signal is “1”, the circuit of FIG. 24 carries out operation equal to that of a binary absolute value adder of a 4 bit width. The block carry propagation circuit BCP1 (see FIG. 8) generating the signals “BCin for non-recomp” and signals “BCin for recomp” has the carry propagation logic of a binary arithmetic circuit as mentioned above. Thus, the conditions for generating the signal RECOMP of the block carry propagation circuit BCP1 are also according to the carry propagation logic of a binary arithmetic circuit. Thus, according to the third embodiment, each of the circuit configurations of the segment absolute value adders depicted in FIG. 9 of the first embodiment is replaced by the circuit configuration of FIG. 24, in the configuration of the decimal absolute value adder body of FIG. 8. As a result, a decimal absolute value adder such as that depicted in FIG. 2, for example, including the decimal absolute value adder body (“decimal absolute adder”) in which each of the segment absolute value adders is thus replaced by the circuit configuration of FIG. 24, can be also used as a binary absolute value adder. It is noted that the decimal absolute value adder body in which each of the segment absolute value adders is replaced by the circuit configuration of FIG. 24 will be referred to as an absolute value adder body 15X.

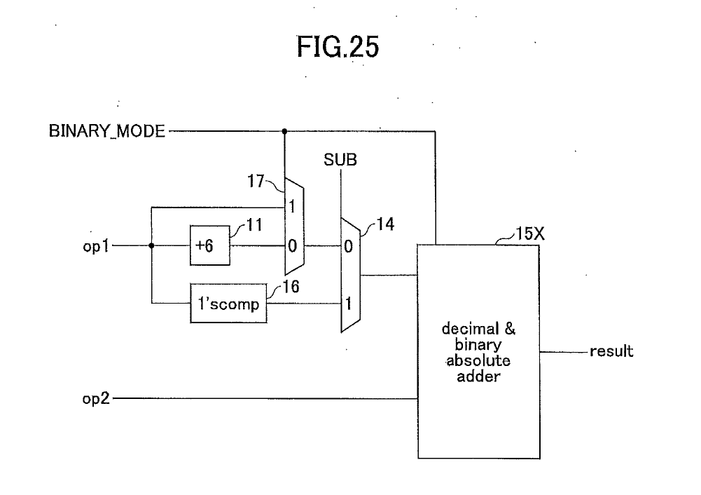

Further, according to the third embodiment, the part of previously carrying out “+6” outside in order to obtain operation as a decimal arithmetic circuit, i.e., for example, the addition circuit 11 in FIG. 3, is unnecessary at a time of binary operation. Thus, the example of the entire configuration of the decimal absolute value adder depicted in FIG. 3 is changed into a configuration of FIG. 25, according to the third embodiment. That is, a selector 17 is inserted. The selector 17 supplies the operand op1 to the selector 14, as it is, in a case where the BINARY_MODE signal is “1”, i.e., at a time of binary operation. On the other hand, in a case where the BINARY_MODE signal is “0”, i.e., at a time of decimal operation, as mentioned above, “+6” operation is carried out by the addition circuit 11 on the operand op1 in digit units, and after that, the operation result is supplied to the selector 14.

Thus, in the configuration of FIG. 25, by the BINARY_MODE signal, at a time of binary operation (BINARY_MODE=1) and at a time of addition (SUB=0), the operand op1 is supplied to the absolute value adder body 15X, as it is. At a time of binary operation (BINARY_MODE=1) and at a time of subtraction (SUB=1), the 1's complement circuit 16 obtains the 1's complement of the operand op1, and obtained 1's complement of the operand op1 is supplied to the absolute value adder body 15X. On the other hand, at a time of decimal operation (BINARY_MODE=0) and at a time of addition (SUB=0), in the same manner as that of the case of FIG. 3, the value obtained from carrying out +6 operation on each digit of the operand op1 is supplied to the absolute value adder body 15X. At a time of decimal operation (BINARY_MODE=0) and at a time of subtraction (SUB=1), a value equal to the value obtained from obtaining the 9's complement of each digit of the operand op1 and carrying out “+6” operation is supplied to the absolute value adder body 15X by the 1's complement circuit 16.

Thus, according to the third embodiment, by the BINARY_MODE signal, it is possible to cause the decimal absolute value adder to operate as the binary absolute value adder and also, as the decimal absolute value adder.

In the embodiments, it is possible to provide the decimal absolute value adder by which it is possible to effectively reduce the processing time for obtaining a decimal absolute value addition result.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A decimal absolute value adder comprises:
a first arithmetic circuit that adds two operands and outputs a first arithmetic operation result;
a second arithmetic circuit that adds the two operands to 10 and outputs a second arithmetic operation result;
a third arithmetic circuit that adds the two operands to 6 and outputs a third arithmetic operation result;
a fourth arithmetic circuit that adds the two operands to 1 and outputs a fourth arithmetic operation result;
a fifth arithmetic circuit that adds the two operands to 11 and outputs a fifth arithmetic operation result;
a sixth arithmetic circuit that adds the two operands to 7 and outputs a sixth arithmetic operation result; and
a selection circuit that
selects any one of the first arithmetic operation result, the second arithmetic operation result, the fourth arithmetic operation result and the fifth arithmetic operation result in a case where an arithmetic operation for the two operands is an addition of numbers having identical signs or in a case where a target arithmetic operation of the two operands is an addition of two numbers having different signs and has an arithmetic operation result that is not negative,
selects a 1's complement of any one of the first arithmetic operation result, the third arithmetic operation result, the fourth arithmetic operation result and the sixth arithmetic operation result in a case where the arithmetic operation for the two operands is an addition of two numbers having different signs and has an arithmetic operation result that is negative, and
outputs a decimal absolute value addition result.

2. The decimal absolute value adder according to claim 1, wherein
the selection circuit
selects any one of the first arithmetic operation result, the second arithmetic operation result, the fourth arithmetic operation result and the fifth arithmetic operation result using a signal indicating whether the arithmetic operation for the two operands is an addition of numbers having identical signs or an addition of numbers having different signs, a carry output signal of the first arithmetic circuit, a carry output signal of the fourth arithmetic circuit and a carry propagation signal from a low digit, and
selects a 1's complement of any one of the first arithmetic operation result, the third arithmetic operation result, the fourth arithmetic operation result and the sixth arithmetic operation result using the carry output signal of the first arithmetic circuit, the carry output signal of the fourth arithmetic circuit and the carry propagation signal from the low digit.

3. The decimal absolute value adder according to claim 1, further comprising:
an inverter circuit that inverts each bit as a circuit that obtains the 1's complement of the arithmetic operation result.

4. The decimal absolute value adder according to claim 1, further comprising:
a first-number-of-digit addition circuit block that combines a first number of single-digit addition circuits and outputs a decimal absolute value addition result of the first number of digits of a decimal number, each single-digit addition circuit of the first number of single-digit addition circuits including the first arithmetic circuit, the second arithmetic circuit, the third arithmetic circuit, the fourth arithmetic circuit, the fifth arithmetic circuit, the sixth arithmetic circuit and the selection circuit, and outputting a decimal absolute value addition result of a single digit of a decimal number;
an inside first-number-of-digit carry generation circuit that is included in the first-number-of-digit addition circuit block and generates carry for the first number of respective single-digit addition circuits;
a third-number-of-digit addition circuit that combines a second number of the first-number-of-digit addition circuit blocks and outputs a decimal absolute value addition result of a third number of digits of a decimal number, the third number being a number obtained from multiplying the first number by the second number; and
a first-number-of-digit-unit carry generation circuit that is included in the third-number-of-digit addition circuit and generates carry for the second number of the respective first-number-of-digit addition circuit blocks.

5. The decimal absolute value adder according to claim 1,
wherein, in order to use the decimal absolute value adder as a binary absolute value adder, the selection circuit has a switching circuit that
causes the first arithmetic operation result or the fourth arithmetic operation result to be selected in a case where the arithmetic operation for the two operands is an addition of numbers having identical signs or an addition of numbers having different signs having an arithmetic operation result that is not negative, and
causes a 1's complement of the first arithmetic operation result or the fourth arithmetic operation result to be selected in a case where the arithmetic operation for the two operands is an addition of numbers having different signs having an arithmetic operation result that is negative.

6. The decimal absolute value adder according to claim 1, wherein
the second arithmetic circuit obtains the second arithmetic operation result obtained from adding two operands to 10 by adding the two operand and subtracting 6,
the third arithmetic circuit obtains the third arithmetic operation result obtained from adding two operands to 6 by adding the two operand and subtracting 10,
the fifth arithmetic circuit obtains the fifth arithmetic operation result obtained from adding two operands to 11 by adding the two operand and subtracting 5, and
the sixth arithmetic circuit obtains the sixth arithmetic operation result obtained from adding two operands to 7 by adding the two operand and subtracting 9.

7. A decimal absolute value adder which carries out a decimal absolute value addition of two operands, the decimal absolute value adder comprising:
a first arithmetic circuit that adds, for one digit of a decimal number, the two operands and outputs a first arithmetic operation result;
a third arithmetic circuit that adds, for the one digit of a decimal number, the two operands to 6 and outputs a third arithmetic operation result; and
a selection circuit that selects a 1's complement of any one of the first arithmetic operation result and the third arithmetic operation result and outputs a decimal absolute value addition result in a case where an arithmetic operation for the two operand is an addition of numbers having different signs, re-complement is to be carried out, and no carry is generated from a low digit for the one digit of a decimal number.

8. A decimal absolute value adder which carries out a decimal absolute value addition of two operands, the decimal absolute value adder comprising:
a fourth arithmetic circuit that adds, for one digit of a decimal number, the two operands to 1 and outputs a fourth arithmetic operation result;
a sixth arithmetic circuit that adds, for the one digit of a decimal number, the two operands to 7 and outputs a sixth arithmetic operation result; and
a selection circuit that selects a 1's complement of any one of the fourth arithmetic operation result and the sixth arithmetic operation result and outputs a decimal absolute value addition result in a case where an arithmetic operation for the two operand is an addition of numbers having different signs, re-complement is to be carried out, and carry is generated from a low digit for the one digit of a decimal number.
